(19) United States
(12) Patent Application Publication
(10) Pub. No.: US 2026/0110885 A1
(43) Pub. Date: Apr. 23, 2026

(54) Optical System and Camera Module

(71) Applicant: NINGBO SUNNY OPOTECH CO., LTD, Yuyao (CN)

(72) Inventors: Anan WU, Yuyao (CN); Yu WU, Yuyao (CN); Hang YU, Yuyao (CN); Meishan GUO, Yuyao (CN); Liguo LIU, Yuyao (CN); Tongji JIANG, Yuyao (CN); Hansheng CEN, Yuyao (CN); Hao ZHANG, Yuyao (CN); Mingfeng CHEN, Yuyao (CN)

(21) Appl. No.: 19/173,712

(22) Filed: Apr. 8, 2025

(30) Foreign Application Priority Data
Oct. 18, 2024 (CN) 202411463502.8

(51) Int. Cl. G02B 13/00; G02B 13/02; G02B 15/14; G03B 17/17; G03B 30/00

(52) U.S. Cl. CPC G02B 13/009; G02B 13/0045; G02B 13/0065; G02B 13/02; G02B 15/1425; G03B 17/17; G03B 30/00

(57) ABSTRACT

The disclosure relates to an optical system and a camera module. The optical system sequentially includes a first element group and a second element group from an object side to an image side along an optical axis, wherein the first element group sequentially includes, from the object side to the image side: a first lens having a positive refractive power, a reflective element, and a second lens having a negative refractive power, and the reflective element is configured for reflecting light emitted from the first lens; the second element group has a positive refractive power, and the second element group is able to move in a direction along the optical axis, so that the optical system switches between a short-focus state and a long-focus state; and the optical system satisfies 0.39<DL/DEFL<0.49.

### CROSS-REFERENCE TO RELATED APPLICATION

This application claims priority to Chinese Patent Application No. 202411463502.8 filed on Oct. 18, 2024, the entire contents of each of which are incorporated herein by reference for all purposes. No new matter has been introduced.

### FIELD

The disclosure relates to the field of optical devices, and in particular to an optical system and a camera module.

### BACKGROUND

With the rapid development of portable electronic devices such as smartphones, telephoto lenses have been widely applied due to the advantages of clear imaging of distant objects, greater magnification, and the ability to present detailed features of the distant objects.

An effective focal length of an optical system is an important standard for measuring whether the optical system is a telephoto lens, and the greater the effective focal length of the optical system is, the clearer a distant object captured by the optical system is. However, the effective focal length of the optical system is proportional to an optical distance required by the optical system, that is, the greater the effective focal length of the optical system, the greater the optical distance required by the optical system is. Therefore, in order to realize telephoto characteristics of the optical system, the total length of an existing optical system is relatively large in general, which severely limits the application of the optical system in the portable electronic devices.

### SUMMARY

In an embodiment of the disclosure, an optical system is provided, sequentially includes a first element group and a second element group from an object side to an image side along an optical axis, wherein the first element group sequentially includes, from the object side to the image side: a first lens having a positive refractive power, a reflective element, and a second lens having a negative refractive power, and the reflective element is configured for reflecting light emitted from the first lens; the second element group has a positive refractive power, and the second element group is able to move in a direction along the optical axis, so that the optical system switches between a short-focus state and a long-focus state; and the optical system satisfies 0.39<DL/DEFL<0.49, the DL is a movable stroke of the second element group, and the DEFL is a variation of an effective focal length of the optical system switching from the long-focus state to the short-focus state.

In an embodiment, the optical system satisfies 0<tan(FOV/2)<0.35 in the short-focus state, wherein the FOV is a maximum field of view of the optical system.

In an embodiment, the optical system satisfies 5.2<D1/CT1<6.0, wherein the D1 is a maximum effective half-aperture of the first lens, and the CT1 is a center thickness of the first lens on the optical axis.

In an embodiment, the optical system satisfies 5.5<D2/CT2<7.5, wherein the D2 is a maximum effective half-aperture of the second lens, and the CT2 is a center thickness of the second lens on the optical axis.

In an embodiment, the optical system satisfies 3.6<|f1/f2|<5.6, wherein the f1 is an effective focal length of the first lens, and the f2 is an effective focal length of the second lens.

In an embodiment, the optical system satisfies 1.2<|FG1/EFL|<1.65 in the short-focus state, wherein the FG1 is an effective focal length of the first element group, and the EFL is an effective focal length of the optical system.

In an embodiment, the optical system satisfies 2.0<|FG1/FG2|<2.5, wherein the FG1 is an effective focal length of the first element group, and the FG2 is an effective focal length of the second element group.

In an embodiment, the optical system satisfies 0.05 mm⁻¹<D2x/EPDx/d12<0.09 mm⁻¹ in the short-focus state, wherein the D2x is a maximum effective half-aperture of the first lens in a first direction, the EPDx is an entrance pupil diameter of the optical system in the first direction, and the d12 is a spacing distance between an image-side surface of the first lens and an object-side surface of the second lens on the optical axis.

In an embodiment, the optical system satisfies 0.05 mm⁻¹<D2y/EPDy/d12<0.09 mm⁻¹ in the short-focus state, wherein the D2y is a maximum effective half-aperture of the second lens in a second direction, the EPDy is an entrance pupil diameter of the optical system in the second direction, and the d12 is a spacing distance between the image-side surface of the first lens and the object-side surface of the second lens on the optical axis.

In an embodiment, the optical system satisfies 0.25<EFL/SL<0.55 in the short-focus state, wherein the EFL is the effective focal length of the optical system, and the SL is a total length of the optical system in a preset primary optical axis direction.

In an embodiment, the second element group sequentially includes, from the first element group to the image side: a third lens having a positive refractive power, a fourth lens having a negative refractive power, a fifth lens having a positive refractive power, a sixth lens having a positive refractive power or negative refractive power, a seventh lens having a positive refractive power, and an eighth lens having a negative refractive power.

In an embodiment, the optical axis includes a first optical axis and a second optical axis, which form a preset angle, and the second optical axis is a preset primary optical axis; and the reflective element includes a plane mirror, the plane mirror receives light emitted from the first lens in the direction of the first optical axis, and reflects the light and then emits the light to the second lens in the direction of the second optical axis.

In another embodiment of the disclosure, a camera module is provided, includes the above optical system, and an imaging element configured for converting an optical image formed by the optical system into an electrical signal.

### BRIEF DESCRIPTION OF DRAWINGS

Other features, objectives and advantages of the disclosure will become more apparent upon reading the detailed description of nonrestrictive embodiments with reference to the following drawings, wherein:

FIG. 1 illustrates a schematic structural diagram of an optical system according to an embodiment of the disclosure;

FIG. 2 illustrates a schematic structural diagram of an optical system including a lens barrel assembly according to an embodiment of the disclosure;

FIG. 3 illustrates a schematic structural diagram of an optical system in a short-focus state according to Embodiment 1 of the disclosure;

FIG. 4 illustrates a schematic structural diagram of the optical system in a long-focus state according to Embodiment 1 of the disclosure;

FIG. 5, FIG. 6, and FIG. 7 respectively illustrate a longitudinal aberration curve, an astigmatism curve and a distortion curve of the optical system in the short-focus state according to Embodiment 1 of the disclosure;

FIG. 8 illustrates a schematic structural diagram of an optical system in a short-focus state according to Embodiment 2 of the disclosure;

FIG. 9 illustrates a schematic structural diagram of the optical system in a long-focus state according to Embodiment 2 of the disclosure;

FIG. 10, FIG. 11, and FIG. 12 respectively illustrate a longitudinal aberration curve, an astigmatism curve and a distortion curve of the optical system in the short-focus state according to Embodiment 2 of the disclosure;

FIG. 13 illustrates a schematic structural diagram of an optical system in a short-focus state according to Embodiment 3 of the disclosure;

FIG. 14 illustrates a schematic structural diagram of the optical system in a long-focus state according to Embodiment 3 of the disclosure;

FIG. 15, FIG. 16, and FIG. 17 respectively illustrate a longitudinal aberration curve, an astigmatism curve and a distortion curve of the optical system in the short-focus state according to Embodiment 3 of the disclosure;

FIG. 18 illustrates a schematic structural diagram of an optical system in a short-focus state according to Embodiment 4 of the disclosure;

FIG. 19 illustrates a schematic structural diagram of the optical system in a short-focus state according to Embodiment 4 of the disclosure;

FIG. 20, FIG. 21, and FIG. 22 respectively illustrate a longitudinal aberration curve, an astigmatism curve and a distortion curve of the optical system in the short-focus state according to Embodiment 4 of the disclosure;

FIG. 23 illustrates a schematic structural diagram of an optical system in a short-focus state according to Embodiment 5 of the disclosure;

FIG. 24 illustrates a schematic structural diagram of the optical system in a long-focus state according to Embodiment 5 of the disclosure;

FIG. 25, FIG. 26, and FIG. 27 respectively illustrate a longitudinal aberration curve, an astigmatism curve and a distortion curve of the optical system in the short-focus state according to Embodiment 5 of the disclosure;

FIG. 28 illustrates a schematic structural diagram of an optical system in a short-focus state according to Embodiment 6 of the disclosure;

FIG. 29 illustrates a schematic structural diagram of the optical system in a long-focus state according to Embodiment 6 of the disclosure;

FIG. 30, FIG. 31, and FIG. 32 respectively illustrate a longitudinal aberration curve, an astigmatism curve and a distortion curve of the optical system in the short-focus state according to Embodiment 6 of the disclosure;

FIG. 33 illustrates a schematic structural diagram of an optical system in a short-focus state according to Embodiment 7 of the disclosure;

FIG. 34 illustrates a schematic structural diagram of the optical system in a long-focus state according to Embodiment 7 of the disclosure; and

FIG. 35, FIG. 36, and FIG. 37 respectively illustrate a longitudinal aberration curve, an astigmatism curve and a distortion curve of the optical system in the short-focus state according to Embodiment 7 of the disclosure.

### DESCRIPTION OF REFERENCE SIGNS

100. optical system; E1. first lens; E2. second lens; E3. third lens; E4. fourth lens; E5. fifth lens; E6. sixth lens; E7. seventh lens; E8. eighth lens; E9. optical filter; P. reflective element; STO. diaphragm; G1. first element group; G2. second element group; IMA. image surface; 200. lens barrel assembly; 210. first lens barrel; 220. second lens barrel.

### DESCRIPTION OF EMBODIMENTS

For a better understanding of the disclosure, various aspects of the disclosure will be described in more detail with reference to the drawings. It should be understood that these detailed descriptions are merely descriptions of exemplary implementations of the disclosure, and are not intended to limit the scope of the disclosure in any way. Throughout the specification, the same reference signs refer to the same elements.

It should be noted that in the present specification, expressions, such as first, second and third, are only configured to distinguish one feature from another feature, but do not indicate any limitation to the feature. Therefore, a first lens discussed below may also be referred to as a second lens or a third lens without departing from the teachings of the disclosure.

In the drawings, for ease of description, the thickness, size and shape of the lens have been slightly exaggerated. Specifically, the shapes of spherical surfaces or aspherical surfaces shown in the drawings are shown by way of instances. That is, the shapes of the spherical surfaces or the aspherical surfaces are not limited to the shapes of the spherical surfaces or the aspherical surfaces shown in the drawings. The drawings are merely examples and are not strictly drawn to scale.

Herein, a paraxial region refers to a region in the vicinity of an optical axis. If the surface of a lens is a convex surface and the position of the convex surface is not defined, it indicates that the surface of the lens is a convex surface at least in the paraxial region; and if the surface of the lens is a concave surface and the position of the concave surface is not defined, it indicates that the surface of the lens is a concave surface at least in the paraxial region. The surface of each lens that is closest to a captured object is referred to as an object-side surface of the lens, and the surface of each lens that is closest to an imaging surface is referred to as an image-side surface of the lens.

It should also be understood that the terms “include” and/or “have”, when configured in the present specification, indicate the presence of stated features, elements and/or components, but do not exclude the presence or addition of one or more other features, elements, components, and/or combinations thereof. In addition, when the implementations of the disclosure are described, “may” is used to present “one or more embodiments of the disclosure”. Moreover, the term “exemplary” is intended to refer to an example or illustration.

Unless otherwise defined, all terms (including technical and scientific terms) used herein have the same meanings as commonly understood by those ordinary skilled in the art to which the disclosure belongs. It should also be understood that terms (e.g., terms defined in commonly used dictionaries) should be interpreted as having meanings consistent with those in the context of the related art and will not be interpreted in an idealized or overly formal sense, unless expressly so defined herein.

It should be noted that, in the case of no conflict, embodiments in the disclosure and features in the embodiments may be combined with each other.

The disclosure will be described in detail below with reference to the drawings and in combination with the embodiments.

A periscopic camera module is a camera module capable of realizing remote photographing. For an optical system in the periscopic camera module, the optical system is able to be provided with a reflective element, and the reflective element increases an effective focal length of the periscopic camera module by turning an optical path, so that the total length of the periscopic camera module is reduced while the periscopic camera module meets a long-focal-length photographing requirement, thereby realizing the miniaturization of the periscopic camera module.

At present, the effective focal lengths of the optical systems of most periscopic camera modules are fixed value, and thus the periscopic camera modules have no zoom capability. When the periscopic camera module is applied to an electronic device, in order to meet photographing requirements under different effective focal lengths, the electronic device usually needs to be matched with a plurality of camera modules with different effective focal lengths, and as the electronic device gradually develops towards a miniaturization direction, the installation space of the camera modules is limited. In addition, when the camera modules with different effective focal lengths are configured for photographing, it is difficult to ensure the imaging quality due to the switching of the camera modules. Therefore, it is desirable to provide a periscopic camera module having a magnification switching function while meeting a miniaturization requirement.

In order to at least partially solve one or more of the above problems or other potential problems, the disclosure provides an optical system, and specifically provides an optical system having a magnification switching function.

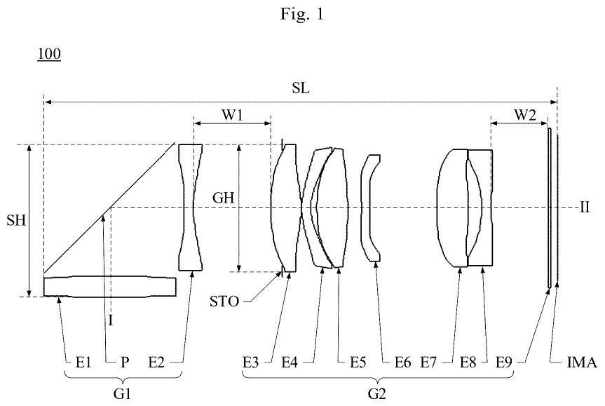

FIG. 1 illustrates a schematic structural diagram of an optical system according to an embodiment of the disclosure. The optical system is able to be applied to, for example, a camera module, and the camera module is able to be, for example, a periscopic camera module. It should be understood that the optical system is able to also be applied to other types of camera modules, which is not specifically limited in the disclosure.

As shown in FIG. 1, an optical system 100 sequentially includes a first element group G1 and a second element group G2 from an object side to an image side along an optical axis. The first element group G1 sequentially includes, from the object side to the image side: a first lens E1 having a positive refractive power, a reflective element P, and a second lens E2 having a negative refractive power. The reflective element P is configured for reflecting light emitted from the first lens E1. The second element group G2 has a positive refractive power. The second element group G2 is able to move in a direction along the optical axis, so that the optical system 100 switches between a short-focus state and a long-focus state. In an embodiment, the image side of the optical system 100 is provided with an image surface IMA.

During the process of the optical system 100 switching from the short-focus state to the long-focus state, the position of the first element group G1 is fixed, the second element group G2 moves towards the first element group G1 along the optical axis (e.g., an optical axis II), an on-axis distance between the first element group G1 and the second element group G2 is reduced, and an on-axis distance between the second element group G2 and the image surface IMA of the optical system 100 is increased until the second element group G2 moves to a first zoom point, so that clear imaging is able to be performed on the image surface IMA. The optical system 100 has a greater effective focal length and magnification in the long-focus state.

During the process of the optical system 100 switching from the long-focus state to the short-focus state, the position of the first element group G1 is fixed, the second element group G2 moves towards the image surface IMA along the optical axis (e.g., the optical axis II), the on-axis distance between the first element group G1 and the second element group G2 is increased, and the on-axis distance between the second element group G2 and the image surface IMA of the optical system 100 is reduced until the second element group G2 moves to a second zoom point, so that clear imaging is able to be performed on the image surface IMA. The optical system 100 has a smaller effective focal length and magnification in the long-focus state.

It should be noted that the long-focus state and the short-focus state of the optical system 100 are relative concepts and do not represent specific values of the effective focal length of the optical system 100, and the effective focal length of the optical system 100 in the long-focus state is greater than the effective focal length of the optical system 100 in the short-focus state.

The first element group G1 is configured for turning an optical path, so that the total length of the optical system 100 is able to be effectively reduced, and the miniaturization requirement is met. The first lens E1 having the positive refractive power is configured for performing beam convergence on the light rays, so that the light rays are still in a beam convergence state after being reflected by the reflective element P, thereby increasing the number of the light rays entering the second lens E2, thus increasing an effective aperture of the optical system 100, and improving the imaging quality of the optical system 100; and moreover, an optical effective aperture of the lens in the second element group G2 is reduced, and a shoulder height of the second element group G2 is reduced, thereby reducing the total height of the optical system 100. The second lens E2 having the negative refractive power is able to perform beam expansion on the light rays, so that the caliber of a lens in a rear-end element group (e.g., the second element group G2) is further reduced, thereby reducing the shoulder height of the rear-end element group.

By reasonably allocating the refractive power of each lens and the number of lenses in the second element group G2, and by changing the on-axis distance between the first element group G1 and the second element group G2, when the second element group G2 moves to the first zoom point, the optical system 100 is in the long-focus state; and when the second element group G2 moves to the second zoom point, the optical system 100 is in the short-focus state, thereby switching the effective focal length and magnification of the optical system 100. In an embodiment, the first lens E1 has a positive refractive power and is configured for performing beam convergence on the light rays. By enabling the first lens E1 to have a beam convergence effect on the light rays, the light rays are still in the beam convergence state after being reflected by the reflective element P, thereby increasing the number of the light rays entering the second lens E2, and increasing the effective aperture (i.e., light incidence) of the optical system 100 without changing a physical caliber of a diaphragm STO. In other words, under the same light condition, the optical system 100 is able to capture more light rays, thereby improving the imaging brightness of the optical system 100. For example, in a dark light environment, the optical system 100 with a large aperture is able to capture more light, which is particularly important for improving the imaging quality of the optical system 100 and the camera module including the optical system 100 in the dark light environment.

In an embodiment, the second lens E2 has a negative refractive power and is able to perform beam expansion on the light rays reflected by the reflective element P. By enabling the second lens E2 to have a beam expansion effect on the light rays, on one hand, under the beam convergence effect of the first lens E1 for the light rays, the caliber of the lens in the rear-end element group is further reduced, thereby reducing the shoulder height of the rear-end element group. In addition, in a case where the reflective element P is driven to achieve optical image stabilization, the position of the light rays on the second element group G2 is less affected by the movement of the reflective element P, and a fall value of an MTF of the optical system 100 is smaller, that is, the stabilization sensitivity is lower; and on the other hand, the first lens E1 has a small caliber, thereby helping to reduce the total length and the total width of the optical system 100. For example, by reasonably allocating the refractive power of the first lens E1 and the refractive power of the second lens E2, the shoulder height, the anti-shake sensitivity, the total length and the total width of the optical system 100 are able to be balanced, so that the optical system 100 has better anti-shake performance while ensuring that the optical system 100 has a smaller size.

In an embodiment, the first lens E1 is a biconvex lens. An object-side surface of the first lens E1 is a convex surface in a paraxial region, and an image-side surface of the first lens E1 is a convex surface in the paraxial region.

In another embodiment, the first lens E1 is a meniscus lens protruding towards the object side. The object-side surface of the first lens E1 is a convex surface in the paraxial region, and the image-side surface thereof is a concave surface in the paraxial region.

In an embodiment, the second lens E2 is a biconcave lens. An object-side surface of the second lens E2 is a convex surface or a concave surface in the paraxial region, and an image-side surface thereof is a concave surface in the paraxial region.

In an embodiment, the object-side surface of the second lens E2 is a convex surface in the paraxial region, the object-side surface of the second lens E2 has an inflection point, so that the object-side surface of the second lens E2 is roughly a concave surface as a whole.

In another embodiment, the second lens E2 is a meniscus lens protruding towards the image side. The object-side surface of the second lens E2 is a concave surface in the paraxial region, and the image-side surface thereof is a convex surface in the paraxial region.

It should be noted that the object-side surface of the first lens E1 or the second lens E2 being a convex surface means that the surface protrudes towards the object side, and the object-side surface of the first lens E1 or the second lens E2 being a concave surface means that the surface recesses towards the object side. The image-side surface of the first lens E1 or the second lens E2 being a convex surface means that the surface protrudes towards the image side, and the image-side surface of the first lens E1 or the second lens E2 being a concave surface means that the surface recesses towards the image side.

In an embodiment, the reflective element P is disposed at any required angle to turn the optical path. The reflective element P is able to be configured such that an incident optical path is deflected by a preset degree (for example, but not limited to, 90°), in an embodiment, the incident optical path is converted from propagating along a first optical axis (referred to as an optical axis I) into propagating along a second optical axis (referred to as optical axis II). It should be understood that the optical axis in the embodiment includes the first optical axis (i.e., the optical axis I) and the second optical axis (i.e., the optical axis II), which form a preset angle, wherein the second optical axis (i.e., the optical axis II) is a preset primary optical axis.

In an embodiment, the reflective element P is disposed between the first lens E1 and the second lens E2, that is, the first lens E1 is located on the optical axis I and is disposed between the object side and the reflective element P, and the second lens E2 is located on the optical axis II and is disposed between the reflective element P and the second element group G2. The reflective element P receives the light rays emitted from the first lens E1 in the direction of the optical axis I, reflects the light rays and then emits the light rays to the second lens E2 in the direction of the optical axis II, wherein the optical axis I and the optical axis II form a preset angle, for example, but not limited to, the optical axis I is perpendicular to the optical axis II.

In an embodiment, the reflective element P is a plane mirror, and the plane mirror has a reflective surface. The light rays emitted from the first lens E1 in the direction of the optical axis I are totally reflected by the reflective surface of the reflective element P to turn and are emitted to the second lens E2 in the direction of the optical axis II. The reflective surface of the reflective element P passes through a point of intersection of the optical axis I and the optical axis II, that is, the reflective surface of the reflective element P is located on both the optical axis I and the optical axis II. By using the plane mirror with a smaller weight and a smaller size as the reflective element, the weight and size of the first element group G1 is able to be constrained within a certain range, thereby reducing the weight and size of the optical system 100 as much as possible, and reducing the driving burden on the reflective element P.

It should be understood that the plane mirror has only the reflective surface and positions thereof facing a light incidence side and a light emergence side are empty, therefore when the first lens E1 is disposed, the first lens E1 is able to be closer to the plane mirror, thereby reducing a height space occupied by the first lens E1 and the reflective element P, and thus reducing the total height of the optical system 100.

In an embodiment, there is a spacing distance between the first lens E1 and the reflective element P. There is a spacing distance between the second lens E2 and the reflective element P. By forming a spacing between the first lens E1 and the reflective element P and a spacing between the second lens E2 and the reflective element P, a plurality of options is able to be provided for the surface type design of the side surfaces of the first lens E1 and the second lens E2 close to the reflective element P, thereby improving the flexibility of the surface type design of the side surfaces of the first lens E1 and the second lens E2 close to the reflective element P.

It should be understood that there being the spacing distance between the first lens E1 and the reflective element P means that there is a certain gap between the side surface of the first lens E1 close to the reflective element P and at least a part of the reflective element P rather than that the first lens E1 is not in contact with the reflective element P at all. Similarly, there being the spacing distance between the second lens E2 and the reflective element P means that the there is a certain gap between the side surface of the second lens E2 close to the reflective element P and at least a part of the reflective element P rather than that the second lens E2 is not in contact with the reflective element P at all.

In an embodiment, a third lens E3, a fourth lens E4, a fifth lens E5, a sixth lens E6, a seventh lens E7 and an eighth lens E8 in the second element group G2 are located on the optical axis II. The third lens E3, the fourth lens E4, the fifth lens E5, the sixth lens E6, the seventh lens E7 and the eighth lens E8 are sequentially arranged from the second lens E2 to the image side along the optical axis II.

In an embodiment, an effective focal length FG2 of the second element group G2 is greater than zero. In an embodiment, a combined focal length of the lenses in the second element group G2 is greater than zero. In other words, the second element group G2 has a positive refractive power.

In an embodiment, the third lens E3 has a positive refractive power, the fourth lens E4 has a negative refractive power, the fifth lens E5 has a positive refractive power, the sixth lens E6 has a positive refractive power or the sixth lens E6 has a negative refractive power in another embodiment, the seventh lens E7 has a positive refractive power, and the eighth lens E8 has a negative refractive power.

In an embodiment, an object-side surface of the third lens E3 is a convex surface in the paraxial region, and an image-side surface thereof is a convex surface in the paraxial region.

In an embodiment, an object-side surface of the fourth lens E4 is a convex surface in the paraxial region, and an image-side surface thereof is a concave surface in the paraxial region.

In an embodiment, an object-side surface of the fifth lens E5 is a convex surface in the paraxial region, and an image-side surface thereof is a convex surface or a concave surface in the paraxial region in another embodiment.

In an embodiment, an object-side surface of the sixth lens E6 is a concave surface in the paraxial region, and an image-side surface thereof is a convex surface in the paraxial region.

In an embodiment, an object-side surface of the seventh lens E7 is a convex surface in the paraxial region, and an image-side surface thereof is a convex surface in the paraxial region.

In an embodiment, an object-side surface of the eighth lens E8 is a concave surface in the paraxial region, and an image-side surface thereof is a concave surface in the paraxial region.

It should be noted that the object-side surface of any of the third lens E3 to the eighth lens E8 being a convex surface means that the surface protrudes towards the object side, and the object-side surface of any of the third lens E3 to the eighth lens E8 being a concave surface means that the surface recesses towards the object side. The image-side surface of any of the third lens E3 to the eighth lens E8 being a convex surface means that the surface protrudes towards the image side, and the image-side surface of any of the third lens E3 to the eighth lens E8 being a concave surface means that the surface recesses towards the image side.

It should be understood that the number of lenses included in the second element group G2 being six is only an example, and the number of lenses included in the second element group G2 is not specifically limited in the disclosure.

In an embodiment, the optical system 100 further includes an optical filter E9. The optical filter E9 is disposed on the image side of the second element group G2, and is configured for filtering the light rays emitted from the second element group G2. The optical filter E9 is an infrared filter in an embodiment.

In an embodiment, the optical system 100 further includes a diaphragm STO. The diaphragm STO is disposed between the second lens E2 and the third lens E3 in an embodiment.

In an embodiment, at least one surface of the first lens E1 to the eighth lens E8 is an aspherical surface. An aspherical lens is characterized in that the curvature continuously changes from the center of the lens to the periphery of the lens. Unlike a spherical lens having a constant curvature from the center of the lens to the periphery of the lens, the aspherical lens has better curvature radius characteristics, and has the advantages of improving distortion aberrations and improving astigmatic aberrations. After the aspherical lens is used, aberrations appearing during imaging are able to be eliminated as much as possible, thereby improving the imaging quality.

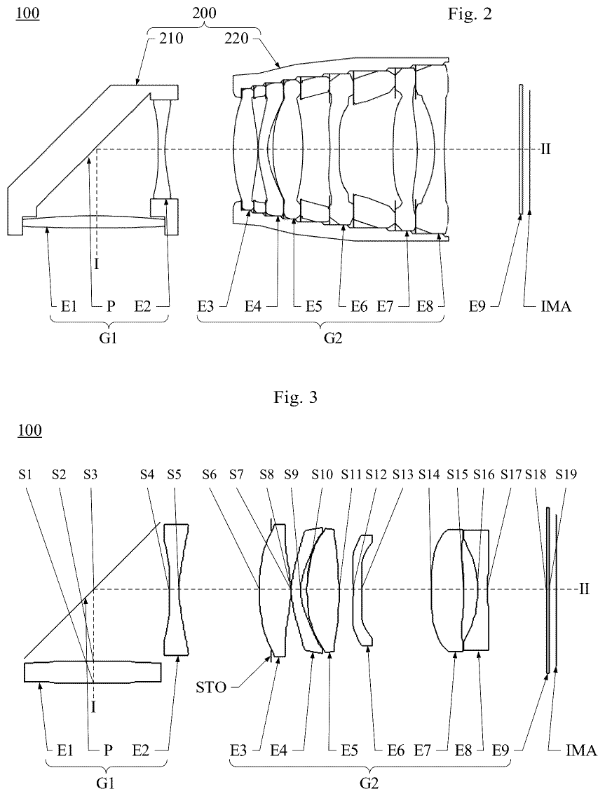

FIG. 2 illustrates a schematic structural diagram of an optical system including a lens barrel assembly according to an embodiment of the disclosure.

In an embodiment, as shown in FIG. 2, the optical system 100 further includes a lens barrel assembly 200. The lens barrel assembly 200 includes a first lens barrel 210 and a second lens barrel 220. The first element group G1 is fixed in the first lens barrel 210. The second element group G2 is fixed in the second lens barrel 220. The first lens barrel 210 is provided with a first opening located on the light incidence side and a second opening located on the light emergence side, the first lens E1 is disposed in the first opening, the second lens E2 is disposed in the second opening, and the reflective element P is disposed between the first opening and the second opening. An inner diameter of the first opening is greater than an inner diameter of the second opening, or the inner diameter of the first opening is equal to the inner diameter of the second opening in another embodiment. The inner diameters of parts of the second lens barrel 220 corresponding to different lenses are different.

During the process of the optical system 100 switching between the short-focus state and the long-focus state, the positions of the first lens barrel 210 and the first element group G1 disposed therein are fixed. The second lens barrel 220 drives the second element group G2 disposed therein to move along the optical axis II.

In an embodiment, during the process of the optical system 100 switching from the short-focus state to the long-focus state, the positions of the first lens barrel 210 and the first element group G1 disposed therein are fixed, and the second lens barrel 220 drives the second element group G2 disposed therein to move towards the first lens barrel 210 along the optical axis II. In another embodiment, during the process of the optical system 100 switching from the short-focus state to the long-focus state, the positions of the first lens barrel 210 and the first element group G1 disposed therein are fixed, and the second lens barrel 220 drives the second element group G2 disposed therein to move towards the image surface IMA along the optical axis II.

In an embodiment, during the process of the optical system 100 switching between the short-focus state and the long-focus state, the second lens barrel 220 and the second element group G2 disposed therein is driven by a first motor (not shown) to move along the optical axis II.

In an embodiment, the optical system 100 is able to satisfy 0.39<DL/DEFL<0.49, wherein the DL is a movable stroke of the second element group G2, and the DEFL is a variation of the effective focal length of the optical system switching from the long-focus state to the short-focus state. In an embodiment, the DL is a moving distance of the second element group G2 along the optical axis II during the process of the optical system 100 switching between the short-focus state and the long-focus state. By reasonably allocating ratios of the movable stroke of the second element group G2 to the variations of the effective focal lengths of the optical system 100 in different states, in a case of a limited moving distance of the second element group G2, the optical system 100 is able to switch between the short-focus state and the long-focus state, and it is ensured that the optical system 100 achieves optimal focusing in both the short-focus state and the long-focus state, thereby ensuring the imaging quality in different states.

In an embodiment, the optical system 100 is able to satisfy 0<tan(FOV/2)<0.35 in the short-focus state, wherein the FOV is a maximum field of view of the optical system 100. By reasonably configuring a tangent value of half of the maximum field of view of the optical system 100, the optical system 100 has a smaller field of view, which facilitates the imaging of a distant object by the optical system 100, thereby ensuring that the optical system 100 has good imaging quality at a long distance.

In an embodiment, the optical system 100 is able to satisfy 5.2<D1/CT1<6.0, wherein the D1 is a maximum effective half-aperture of the first lens E1, and the CT1 is a center thickness of the first lens E1 on the optical axis (e.g., the optical axis I). In an embodiment, the D1 is a maximum value among an effective half-aperture of the object-side surface of the first lens E1 in a first direction, an effective half-aperture of the object-side surface of the first lens E1 in a third direction, an effective half-aperture of the image-side surface of the first lens E1 in one direction, and an effective half-aperture of the image-side surface of the first lens E1 in the third direction, wherein the first direction is a direction perpendicular to a plane formed by the optical axis I and the optical axis II; and the third direction is a direction parallel to the optical axis II. By reasonably configuring a ratio of the maximum effective half-aperture D1 of the first lens E1 to the center thickness CT1 of the first lens E1, in a case where the machinability requirement of the first lens E1 is satisfied, the total height of the optical system 100 is able to be reduced, and the structure of the optical system 100 is more compact, thereby reducing the volume of the optical system 100, and facilitating to improve the aperture of the optical system 100.

In an embodiment, the optical system 100 is able to satisfy 5.5<D2/CT2<7.5, wherein the D2 is a maximum effective half-aperture of the second lens E2, and the CT2 is a center thickness of the second lens E2 on the optical axis (e.g., the optical axis II). In an embodiment, the D2 is a maximum value among an effective half-aperture of the object-side surface of the second lens E2 in the first direction, an effective half-aperture of the object-side surface of the first lens E1 in a second direction, an effective half-aperture of the image-side surface of the second lens E2 in the first direction, and an effective half-aperture of the second lens E2 in the second direction, wherein the first direction is the direction perpendicular to the plane formed by the optical axis I and the optical axis II; and the second direction is the direction parallel to the optical axis II. By reasonably configuring a ratio of the maximum effective half-aperture D2 of the second lens E2 to the center thickness CT2 of the second lens E2, in a case where the machinability requirement of the second lens E2 is satisfied, the total height of the optical system 100 is able to be reduced, and the structure of the optical system 100 is more compact, thereby reducing the volume of the optical system 100.

In an embodiment, the optical system 100 is able to satisfy 3.6<|f1/f2|<5.6, wherein the f1 is an effective focal length of the first lens E1, and the f2 is an effective focal length of the second lens E2. By reasonably configuring a ratio of the effective focal length of the first lens E1 to the effective focal length of the second lens E2, the first lens E1 is able to have a higher beam convergence capability for light, have a higher expansion effect for the aperture, and ensure that the light rays are still in a beam convergence state after being reflected by the reflective element P, which is beneficial to reducing the aperture of the second lens E2, thereby reducing the aperture of the lens in the rear-end element group (e.g., the second element group G2), and reducing the shoulder height of the rear-end element group.

In an embodiment, the optical system 100 is able to satisfy 1.2<|FG1/EFL|<1.65 in the short-focus state, wherein the FG1 is an effective focal length of the first element group G1, and the EFL is an effective focal length of the optical system 100. By reasonably configuring a ratio of the effective focal length of the first element group G1 to the effective focal length of the optical system 100, the first element group G1 is able to have a certain beam convergence capability, thereby achieving a beam convergence effect on the light rays, and thus facilitating to reduce the shoulder height of the rear-end element group.

In an embodiment, the optical system 100 is able to satisfy 2.0<|FG1/FG2|<2.5, wherein the FG1 is the effective focal length of the first element group G1, and the FG2 is an effective focal length of the second element group G2. By reasonably configuring a ratio of the effective focal length of the first element group G1 to the effective focal length of the second element group G2, in a case of a limited moving distance of the second element group G2, the optical system 100 is able to switch between the short-focus state and the long-focus state, and it is ensured that the optical system 100 achieves optimal focusing both in the short-focus state and the long-focus state, thereby ensuring the imaging quality in different states.

In an embodiment, at least one of the second lens E2 to the eighth lens E8 is able to be a trimmed lens. The trimmed lens is able to have different half-apertures in the first direction and the second direction. In an embodiment, the first lens E1 is also a trimmed lens, and the trimmed lens is able to have different half-apertures in the first direction and the third direction. In an embodiment, the first direction is the direction perpendicular to the plane formed by the optical axis I and the optical axis II; the second direction is the direction parallel to the optical axis I; and the third direction is the direction parallel to the optical axis II. By setting the trimmed lens, the total width of the rear-end element group (e.g., the second element group G2) in the first direction or the shoulder height of the rear-end element group is able to be further reduced, thereby reducing the total width of the optical system 100 in the first direction or the total height of the optical system 100.

In an embodiment, the optical system 100 is able to satisfy 0.05 mm⁻¹<D2x/EPDx/d12<0.09 mm⁻¹ in the short-focus state, wherein the D2x is a maximum effective half-aperture of the second lens E2 in the first direction, the EPDx is an entrance pupil diameter of the optical system 100 in the first direction, and d12 is a spacing distance between the image-side surface of the first lens and the object-side surface of the second lens on the optical axis. In an embodiment, the D2x is a maximum value in the effective half-aperture of the object-side surface of the second lens E2 in the first direction and the effective half-aperture of the image-side surface of the second lens E2 in the first direction. By constraining the above conditional expression, while the optical system 100 meets the large aperture requirement, the effective aperture of the second lens E2 is able to be constrained within a reasonable range, which is beneficial to reducing the total width of the second element group G2 in the first direction, thereby reducing the total width of the optical system 100 in the first direction.

In an embodiment, the optical system 100 is able to satisfy 0.05 mm⁻¹<D2y/EPDy/d12<0.09 mm⁻¹ in the short-focus state, wherein the D2y is a maximum effective half-aperture of the second lens E2 in the second direction, the EPDy is an entrance pupil diameter of the optical system 100 in the second direction, and d12 is a spacing distance between the image-side surface of the first lens and the object-side surface of the second lens on the optical axis. In an embodiment, the D2y is able to be a maximum value in the effective half-aperture of the object-side surface of the second lens E2 in the second direction and the effective half-aperture of the image-side surface of the second lens E2 in the second direction. The second direction is able to be, for example, the direction parallel to the optical axis I. By constraining the above conditional expression, while the optical system 100 meets the large aperture requirement, the effective aperture of the second lens E2 is able to be constrained within a reasonable range, which is beneficial to reducing the shoulder height of the second element group G2, thereby reducing the total height of the optical system 100.

In an embodiment, the optical system 100 is able to satisfy 0.25<EFL/SL<0.55 in the short-focus state, wherein the EFL is an effective focal length of the optical system 100, and the SL is a total length of the optical system 100 in a preset primary optical axis direction (e.g., the optical axis II). By reasonably configuring the ratio of the effective focal length of the optical system 100 to the total length of the optical system 100, the total length of the optical system 100 is able to be reduced while the optical system 100 has telephoto characteristics.

In the embodiments of the disclosure, the SL represents the total length of the optical system 100 in the preset primary optical axis (e.g., the optical axis II) direction, and in an embodiment, the SL is a spacing distance between the first lens E1 and the image surface IMA on the optical axis II. The GH represents the shoulder height of the rear-end element group (e.g., the second element group G2), and in an embodiment, the GH is determined by a maximum aperture of each lens in the second element group G2 in the second direction (e.g., the direction parallel to the optical axis I). The SH represents the total height of the optical system 100, and in an embodiment, the SH is the total height of the optical system 100 in the second direction (e.g., the direction parallel to the optical axis I). The d12 represents the spacing distance between the image-side surface of the first lens and the object-side surface of the second lens on the optical axis, and in an embodiment, the d12 is the sum of the distance between the image-side surface of the first lens E1 and the reflective element P along the optical axis I and the distance between the reflective element P and the object-side surface of the second lens E2 along the optical axis II.

It should be understood by those skilled in the art that, without departing from the technical solutions claimed in the disclosure, the number of lenses constituting the optical system 100 is able to be changed to obtain the various results and advantages described in the present specification.

Specific embodiments of the optical system applicable to the above implementations are further described below with reference to the drawings.

### Embodiment 1

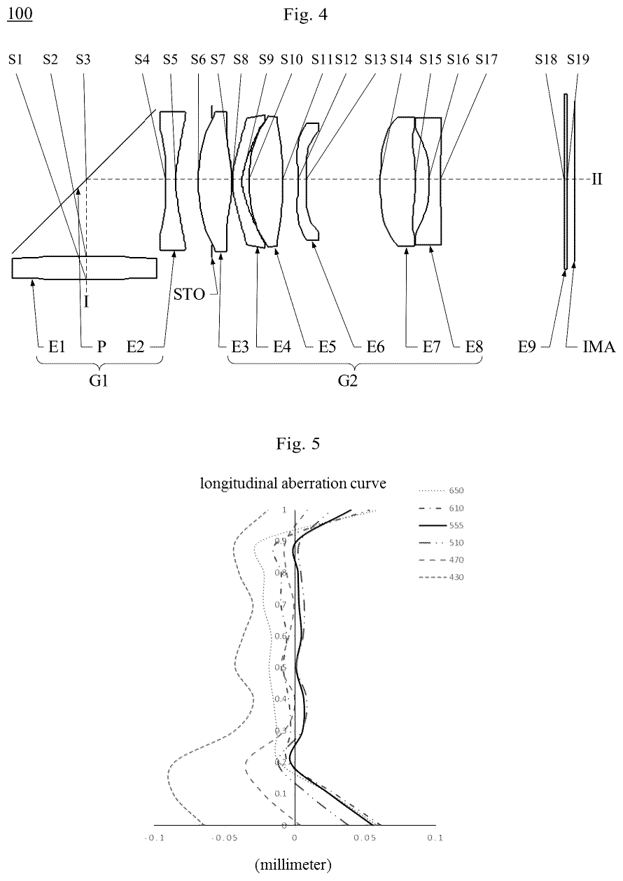

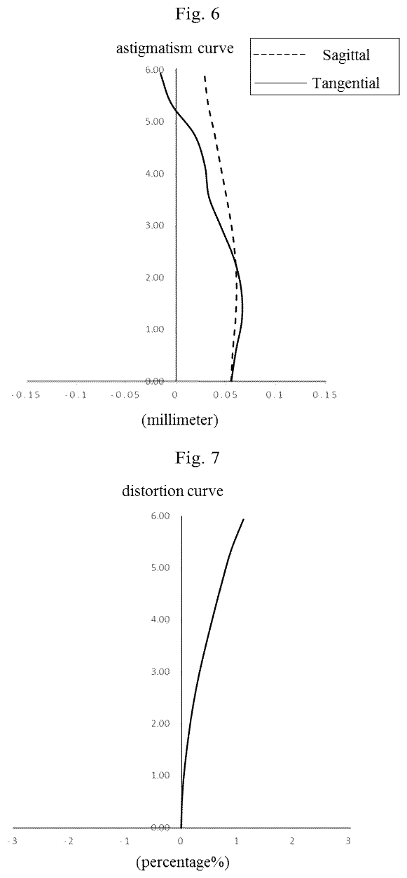

An optical system of Embodiment 1 is described below with reference to FIG. 3, FIG. 4, FIG. 5, FIG. 6 and FIG. 7. FIG. 3 illustrates a schematic structural diagram of the optical system in a short-focus state according to Embodiment 1 of the disclosure. FIG. 4 illustrates a schematic structural diagram of the optical system in a long-focus state according to Embodiment 1 of the disclosure.

As shown in FIG. 3 and FIG. 4, the optical system 100 includes a first element group G1 and a second element group G2, which are sequentially arranged from an object side to an image side. The image side is provided with an image surface IMA.

The first element group G1 includes a first lens E1, a reflective element P, and a second lens E2. The second element group G2 includes a third lens E3, a fourth lens E4, a fifth lens E5, a sixth lens E6, a seventh lens E7, and an eighth lens E8. The first lens E1 is located on an optical axis I and is disposed between the object side and the reflective element P. The second lens E2, the third lens E3, the fourth lens E4, the fifth lens E5, the sixth lens E6, the seventh lens E7 and the eighth lens E8 are sequentially arranged from the reflective element P to the image side along an optical axis II. An optical filter E9 is disposed between the eighth lens E8 and the image surface IMA. A diaphragm STO is disposed between the second lens E2 and the third lens E3.

The first lens E1 has a positive refractive power, an object-side surface S1 thereof is a convex surface, and an image-side surface S2 thereof is a convex surface. The reflective element P has a reflective surface S3, and the reflective surface S3 is a plane. The second lens E2 has a negative refractive power, an object-side surface S4 thereof is a convex surface, and an image-side surface S5 thereof is a concave surface. The third lens E3 has a positive refractive power, an object-side surface S6 thereof is a convex surface, and an image-side surface S7 thereof is a convex surface. The fourth lens E4 has a negative refractive power, an object-side surface S8 thereof is a convex surface, and an image-side surface S9 thereof is a concave surface. The fifth lens E5 has a positive refractive power, an object-side surface S10 thereof is a convex surface, and an image-side surface S11 thereof is a convex surface. The sixth lens E6 has a negative refractive power, an object-side surface S12 thereof is a concave surface, and an image-side surface S13 thereof is a convex surface. The seventh lens E7 has a positive refractive power, an object-side surface S14 thereof is a convex surface, and an image-side surface S15 thereof is a convex surface. The eighth lens E8 has a negative refractive power, an object-side surface S16 thereof is a concave surface, and an image-side surface S17 thereof is a concave surface. The optical filter E9 has an object-side surface S18 and an image-side surface S19. Light rays from an object sequentially pass through the surfaces S1 to S19 and are finally imaged on the image surface IMA.

Table 1 illustrates basic parameters of the optical system 100 of Embodiment 1, wherein the units of curvature radius and thickness/distance are millimeters (mm). In the present embodiment, the positive and negative attributes of a numerical symbol of the curvature radius of each surface represents a turning direction of the surface. When the turning directions of the surfaces of lenses on the optical axis I and an optical axis II are the same, the positive and negative attributes of the numerical symbols of the curvature radiuses of the surfaces are opposite. Likewise, the positive and negative attributes of the numerical symbol of the thickness/distance of each surface only represents a direction.

TABLE 1

| | | | | | | Material | | |
|---|---|---|---|---|---|---|---|---|
| Surface | | Surface | Curvature | Thickness/ | | Refractive | Abbe | Focal |
| number | Element | type | radius | distance | Material | index | number | length |
| S1 | First lens | Aspherical | 227.2001 | 1.8000 | Plastic | 1.671 | 19.400 | 72.49 |
| | | surface | | | | | | |
| S2 | | Aspherical | −62.4621 | 5.7887 | | | | |
| | | surface | | | | | | |
| S3 | Reflective | Spherical | Infinite | −6.2784 | Glass | | | |
| | element | surface | | | | | | |
| S4 | Second lens | Aspherical | −78.7911 | −0.8169 | Plastic | 1.571 | 39.082 | −14.53 |
| | | surface | | | | | | |
| S5 | | Aspherical | −7.5109 | W1 | | | | |
| | | surface | | | | | | |
| STO | Aperture | Spherical | Infinite | 1.0196 | | | | |
| | | surface | | | | | | |
| S6 | Third lens | Aspherical | −14.8061 | −2.6000 | Plastic | 1.541 | 56.093 | 9.40 |
| | | surface | | | | | | |
| S7 | | Aspherical | 7.3034 | −0.0400 | | | | |
| | | surface | | | | | | |
| S8 | Fourth lens | Aspherical | −4.9325 | −0.7481 | Plastic | 1.658 | 20.865 | −17.54 |
| | | surface | | | | | | |
| S9 | | Aspherical | −3.2544 | −0.5437 | | | | |
| | | surface | | | | | | |
| S10 | Fifth lens | Aspherical | −17.0074 | −2.6000 | Plastic | 1.516 | 56.989 | 20.20 |
| | | surface | | | | | | |
| S11 | | Aspherical | 25.7683 | −1.2160 | | | | |
| | | surface | | | | | | |
| S12 | Sixth lens | Aspherical | 8.4383 | −0.6576 | Plastic | 1.654 | 21.248 | −41.86 |
| | | surface | | | | | | |
| S13 | | Aspherical | 12.5268 | −5.7229 | | | | |
| | | surface | | | | | | |
| S14 | Seventh lens | Aspherical | −62.5062 | −2.6995 | Plastic | 1.671 | 19.402 | 16.14 |
| | | surface | | | | | | |
| S15 | | Aspherical | 13.0193 | −1.0797 | | | | |
| | | surface | | | | | | |
| S16 | Eighth lens | Aspherical | 14.6990 | −0.8355 | Plastic | 1.545 | 55.928 | −12.60 |
| | | surface | | | | | | |
| S17 | | Aspherical | −13.2231 | W2 | | | | |
| | | surface | | | | | | |
| S18 | Optical filter | Spherical | Infinite | −0.2272 | Glass | 1.517 | 64.210 | |
| | | surface | | | | | | |
| S19 | | Spherical | Infinite | −0.5261 | | | | |
| | | surface | | | | | | |
| IMA | Image surface | Spherical | Infinite | | | | | |
| | | surface | | | | | | |

During the process of the optical system 100 switching from the short-focus state to the long-focus state, the position of the first element group G1 is fixed, and the second element group G2 moves towards the first element group G1 along the optical axis II. During the process of the optical system 100 switching from the long-focus state to the short-focus state, the position of the first element group G1 is fixed, the second element group G2 moves towards the image surface IMA along the optical axis II.

As shown in FIG. 3, when the optical system 100 is in the short-focus state, a spacing distance W1 between the first element group G1 and the second element group G2 (i.e., the image-side surface S5 of the second lens E2 and the object-side surface S6 of the third lens E3) on the optical axis II is 7.5895 mm, and a spacing distance W2 between the second element group G2 and the optical filter E9 (i.e., the image-side surface S17 of the eighth lens E8 and the object-side surface S18 of the optical filter E9) on the optical axis II is 4.8435 mm. At this time, an effective focal length EFL of the optical system 100 is 18.50 mm. As shown in FIG. 4, when the optical system 100 is in the long-focus state, the spacing distance W1 between the first element group G1 and the second element group G2 (i.e., the image-side surface S5 of the second lens E2 and the object-side surface S6 of the third lens E3) on the optical axis II is 2.7902 mm, and the spacing distance W2 between the second element group G2 and the optical filter E9 (i.e., the image-side surface S17 of the eighth lens E8 and the object-side surface S18 of the optical filter E9) on the optical axis II is 9.6428 mm. At this time, the effective focal length EFL of the optical system 100 is 29.40 mm.

In the present embodiment, the object-side surface and the image-side surface of any lens among the first lens E1 to the eighth lens E8 are aspherical surfaces, and the surface type of each aspherical lens is able to be defined by using, but not limited to, the following aspherical formula:

$$X ( Y ) = \frac{( {Y}^{2} / R )}{1 + \sqrt{1 - ( 1 + K ) ( {Y}^{2} / {R}^{2} )}} + \sum {A}_{i} {Y}^{i} ; \qquad ( 1 )$$

Wherein X(Y) represents a relative distance between a point on an aspherical surface that is away from the optical axis by a distance Y and a tangent plane tangent to an intersection of the aspherical surface and the optical axis; Y represents a vertical distance between a point on an aspherical curve and the optical axis; R represents a curvature radius; K represents a conic coefficient, and Aᵢ represents an ith-order aspherical coefficient. Table 2 shows conic coefficients K and high-order coefficients A₄, A₆, A₈, A₁₀, A₁₂, A₁₄, A₁₆, A₁₈ and A₂₀, which is applied to the aspherical surfaces S1-S2 and S4-S17 in Embodiment 1.

TABLE 2

| Surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | 89.998 | 4.60E−01 | 1.49E−02 | 4.92E−03 | 4.74E−03 | 4.65E−04 | 2.00E−06 | −9.54E−05 | −1.00E−07 | 4.83E−05 |
| S2 | −78.938 | 1.97E−01 | 2.55E−02 | 1.10E−03 | 4.85E−03 | −6.40E−06 | −5.20E−06 | −9.94E−05 | 2.32E−05 | 4.24E−05 |
| S4 | 61.333 | 1.05E+00 | −1.62E−01 | 3.51E−02 | −8.21E−03 | 2.37E−03 | −4.41E−04 | 1.62E−04 | 9.50E−06 | 1.02E−05 |
| S5 | −13.799 | 2.20E−01 | −4.74E−02 | 1.03E−02 | −1.86E−03 | 5.73E−04 | 1.32E−04 | −1.00E−06 | 6.15E−05 | −7.00E−06 |
| S6 | −28.930 | −5.84E−01 | 4.16E−02 | −8.76E−03 | 4.25E−03 | −1.24E−03 | 1.81E−04 | −7.23E−05 | −5.78E−05 | 1.15E−04 |
| S7 | 0.613 | −1.71E+00 | 1.16E−01 | −4.72E−02 | 1.38E−02 | −6.97E−03 | 2.49E−03 | −1.23E−03 | 3.53E−04 | 1.41E−04 |
| S8 | −0.042 | 2.25E+00 | −7.52E−02 | 8.16E−02 | −7.93E−03 | 6.60E−03 | 1.53E−03 | 2.29E−04 | 2.80E−04 | 4.32E−04 |
| S9 | −2.333 | 7.59E−01 | −2.29E−01 | 5.36E−02 | −3.31E−02 | 9.20E−03 | −3.77E−03 | 1.46E−03 | 4.50E−04 | 2.25E−04 |
| S10 | 4.601 | −5.18E−01 | 6.34E−02 | −3.56E−02 | 4.25E−03 | 1.54E−03 | −1.06E−03 | 1.03E−03 | 8.00E−04 | −3.73E−04 |
| S11 | −7.448 | −1.76E−02 | 2.98E−02 | −3.54E−02 | 1.81E−02 | −3.41E−03 | 2.30E−04 | 2.89E−04 | −4.65E−04 | −4.70E−05 |
| S12 | 1.120 | −1.98E+00 | 2.18E−01 | −5.81E−02 | 1.57E−02 | −5.58E−03 | 8.78E−04 | −7.47E−05 | −3.12E−04 | 6.25E−05 |
| S13 | 5.226 | −1.84E+00 | 1.40E−01 | −2.37E−02 | 4.08E−03 | −2.05E−03 | 1.02E−04 | 8.42E−05 | −1.91E−04 | 3.90E−06 |
| S14 | 76.203 | −7.57E−01 | 5.42E−03 | −7.38E−03 | 9.53E−04 | −2.42E−04 | 1.68E−04 | 5.97E−05 | 2.80E−06 | 5.50E−06 |
| S15 | −14.088 | −4.02E−01 | −3.50E−02 | −1.09E−02 | −2.58E−04 | −8.17E−04 | 2.59E−05 | 1.37E−04 | 5.57E−05 | −1.70E−06 |
| S16 | −21.016 | 7.75E−01 | −1.63E−01 | 2.07E−02 | −4.71E−03 | −1.80E−04 | −5.97E−05 | 1.60E−04 | −4.01E−05 | −3.08E−05 |
| S17 | −52.417 | 4.23E−01 | −1.21E−01 | 2.46E−02 | −5.01E−03 | 7.43E−04 | −6.49E−05 | 4.11E−05 | −5.26E−05 | −2.07E−05 |

FIG. 5 illustrates a longitudinal aberration curve of the optical system 100 of Embodiment 1 in the short-focus state, and the longitudinal aberration curve represents deviations of focal points of light of different wavelengths after passing through the optical system 100. FIG. 6 illustrates an astigmatism curve of the optical system 100 of Embodiment 1 in the short-focus state, and the astigmatism curve represents meridianal image surface bending and sagittal image surface bending corresponding to different image heights. FIG. 7 illustrates a distortion curve of the optical system 100 of Embodiment 1 in the short-focus state, and the distortion curve represents distortion magnitudes corresponding to different image heights. It can be seen from FIG. 5, FIG. 6 and FIG. 7 that the optical system 100 of Embodiment 1 is able to achieve good imaging quality in the short-focus state.

### Embodiment 2

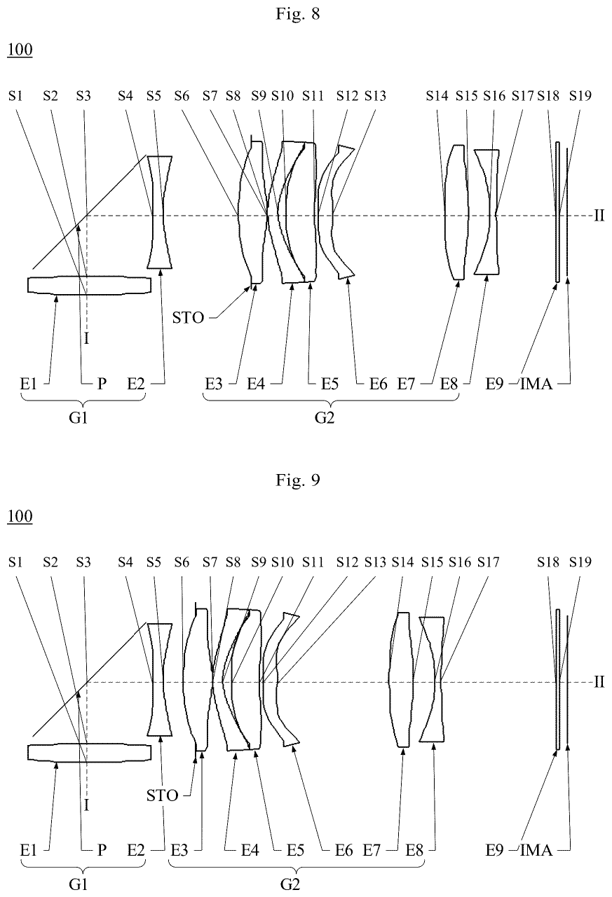

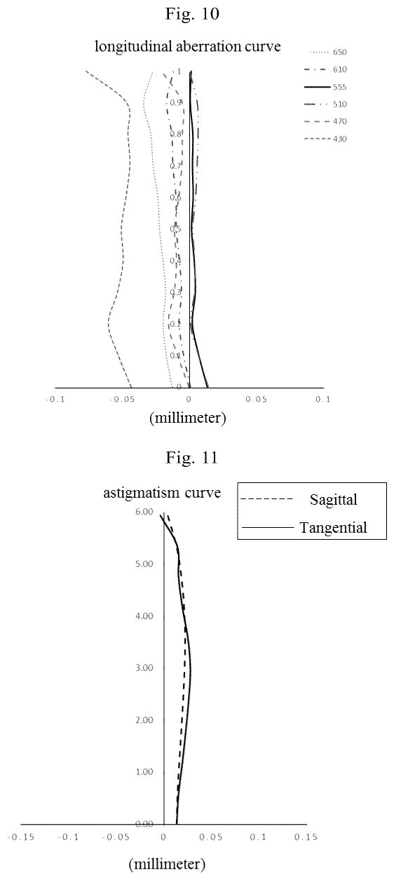

An optical system of Embodiment 2 is described below with reference to FIG. 8, FIG. 9, FIG. 10, FIG. 11 and FIG. 12. In the present embodiment and following embodiments, for the sake of brevity, a part of descriptions similar to Embodiment 1 will be omitted. FIG. 8 illustrates a schematic structural diagram of the optical system in a short-focus state according to Embodiment 2 of the disclosure. FIG. 9 illustrates a schematic structural diagram of the optical system in a long-focus state according to Embodiment 2 of the disclosure.

As shown in FIG. 8 and FIG. 9, the optical system 100 includes a first element group G1 and a second element group G2, which are sequentially arranged from an object side to an image side. The image side is provided with an image surface IMA.

The first element group G1 includes a first lens E1, a reflective element P, and a second lens E2. The second element group G2 includes a third lens E3, a fourth lens E4, a fifth lens E5, a sixth lens E6, a seventh lens E7, and an eighth lens E8. The first lens E1 is located on an optical axis I and is disposed between the object side and the reflective element P. The second lens E2, the third lens E3, the fourth lens E4, the fifth lens E5, the sixth lens E6, the seventh lens E7 and the eighth lens E8 are sequentially arranged from the reflective element P to the image side along an optical axis II. An optical filter E9 is disposed between the eighth lens E8 and the image surface IMA. A diaphragm STO is disposed between the second lens E2 and the third lens E3.

The first lens E1 has a positive refractive power, an object-side surface S1 thereof is a convex surface, and an image-side surface S2 thereof is a convex surface. The reflective element P has a reflective surface S3, and the reflective surface S3 is a plane. The second lens E2 has a negative refractive power, an object-side surface S4 thereof is a convex surface, and an image-side surface S5 thereof is a concave surface. The third lens E3 has a positive refractive power, an object-side surface S6 thereof is a convex surface, and an image-side surface S7 thereof is a convex surface. The fourth lens E4 has a negative refractive power, an object-side surface S8 thereof is a convex surface, and an image-side surface S9 thereof is a concave surface. The fifth lens E5 has a positive refractive power, an object-side surface S10 thereof is a convex surface, and an image-side surface S11 thereof is a concave surface. The sixth lens E6 has a positive refractive power, an object-side surface S12 thereof is a concave surface, and an image-side surface S13 thereof is a convex surface. The seventh lens E7 has a positive refractive power, an object-side surface S14 thereof is a convex surface, and an image-side surface S15 thereof is a convex surface. The eighth lens E8 has a negative refractive power, an object-side surface S16 thereof is a concave surface, and an image-side surface S17 thereof is a concave surface. The optical filter E9 has an object-side surface S18 and an image-side surface S19. Light rays from an object sequentially pass through the surfaces S1 to S19 and are finally imaged on the image surface IMA.

Table 3 illustrates basic parameters of the optical system 100 of Embodiment 2, wherein the units of curvature radius and thickness/distance are millimeters (mm).

TABLE 3

| | | | | | | Material | | |
|---|---|---|---|---|---|---|---|---|
| Surface | | Surface | Curvature | Thickness/ | | Refractive | Abbe | Focal |
| number | Element | type | radius | distance | Material | index | number | length |
| S1 | First lens | Aspherical | 89.0130 | 1.8000 | Plastic | 1.671 | 19.400 | 64.51 |
| | | surface | | | | | | |
| S2 | | Aspherical | −85.1933 | 6.2138 | | | | |
| | | surface | | | | | | |
| S3 | Reflective | Spherical | Infinite | −6.2116 | | | | |
| | element | surface | | | | | | |
| S4 | Second lens | Aspherical | −133.3064 | −0.9357 | Plastic | 1.591 | 32.397 | −16.54 |
| | | surface | | | | | | |
| S5 | | Aspherical | −9.1251 | W1 | | | | |
| | | surface | | | | | | |
| STO | Aperture | Spherical | Infinite | 1.1991 | | | | |
| | | surface | | | | | | |
| S6 | Third lens | Aspherical | −23.3086 | −2.8000 | Plastic | 1.541 | 56.101 | 12.88 |
| | | surface | | | | | | |
| S7 | | Aspherical | 9.5639 | −0.0400 | | | | |
| | | surface | | | | | | |
| S8 | Fourth lens | Aspherical | −6.7546 | −0.9986 | Plastic | 1.671 | 19.400 | −22.41 |
| | | surface | | | | | | |
| S9 | | Aspherical | −4.3960 | −0.8090 | | | | |
| | | surface | | | | | | |
| S10 | Fifth lens | Aspherical | −25.4655 | −2.8000 | Plastic | 1.545 | 55.959 | 57.77 |
| | | surface | | | | | | |
| S11 | | Aspherical | −126.2912 | −0.3457 | | | | |
| | | surface | | | | | | |
| S12 | Sixth lens | Aspherical | 50.2069 | −1.3566 | Plastic | 1.520 | 56.298 | 72.31 |
| | | surface | | | | | | |
| S13 | | Aspherical | 21.7370 | −10.9391 | | | | |
| | | surface | | | | | | |
| S14 | Seventh lens | Aspherical | −68.7632 | −2.3623 | Plastic | 1.671 | 19.400 | 22.72 |
| | | surface | | | | | | |
| S15 | | Aspherical | 19.5603 | −2.1166 | | | | |
| | | surface | | | | | | |
| S16 | Eighth lens | Aspherical | 13.0902 | −0.6000 | Plastic | 1.545 | 55.959 | −17.42 |
| | | surface | | | | | | |
| S17 | | Aspherical | −35.5021 | W2 | | | | |
| | | surface | | | | | | |
| S18 | Optical filter | Spherical | Infinite | −0.3115 | Glass | 1.517 | 64.210 | |
| | | surface | | | | | | |
| S19 | | Spherical | Infinite | −0.7214 | | | | |
| | | surface | | | | | | |
| IMA | Image surface | Spherical | Infinite | | | | | |
| | | surface | | | | | | |

During the process of the optical system 100 switching from the short-focus state to the long-focus state, the position of the first element group G1 is fixed, and the second element group G2 moves towards the first element group G1 along the optical axis IL. During the process of the optical system 100 switching from the long-focus state to the short-focus state, the position of the first element group G1 is fixed, the second element group G2 moves towards the image surface IMA along the optical axis II.

As shown in FIG. 8, when the optical system 100 is in the short-focus state, a spacing distance W1 between the first element group G1 and the second element group G2 (i.e., the image-side surface S5 of the second lens E2 and the object-side surface S6 of the third lens E3) on the optical axis II is 8.5981 mm, and a spacing distance W2 between the second element group G2 and the optical filter E9 (i.e., the image-side surface S17 of the eighth lens E8 and the object-side surface S18 of the optical filter E9) on the optical axis II is 5.8528 mm. At this time, an effective focal length EFL of the optical system 100 is 25.36 mm. As shown in FIG. 9, when the optical system 100 is in the long-focus state, the spacing distance W1 between the first element group G1 and the second element group G2 (i.e., the image-side surface S5 of the second lens E2 and the object-side surface S6 of the third lens E3) on the optical axis II is 3.1970 mm, and the spacing distance W2 between the second element group G2 and the optical filter E9 (i.e., the image-side surface S17 of the eighth lens E8 and the object-side surface S18 of the optical filter E9) on the optical axis II is 11.2539 mm. At this time, the effective focal length EFL of the optical system 100 is 38.00 mm.

In the present embodiment, the object-side surface and the image-side surface of any lens among the first lens E1 to the eighth lens E8 are aspherical surfaces. Table 4 shows conic coefficients K and high-order coefficients A₄, A₆, A₈, A₁₀, A₁₂, A₁₄, A₁₆, A₁₈ and A₂₀, which is applied to the aspherical surfaces S1-S2 and S4-S17 in Embodiment 2.

TABLE 4

| Surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | 30.632 | 1.63E−01 | 2.93E−03 | 2.04E−03 | 1.69E−03 | 3.17E−04 | 1.28E−04 | 4.90E−05 | −5.00E−06 | 9.00E−06 |
| S2 | −24.665 | 2.02E−01 | 1.37E−04 | 2.07E−03 | 1.64E−03 | 2.25E−04 | 1.13E−04 | 3.90E−05 | −4.00E−06 | 1.00E−05 |
| S4 | 89.507 | 9.80E−01 | −1.51E−01 | 3.28E−02 | −8.19E−03 | 2.03E−03 | −5.38E−04 | 1.06E−04 | −2.20E−05 | 5.00E−06 |
| S5 | −12.272 | 1.78E−01 | −4.74E−02 | 1.21E−02 | −3.28E−03 | 7.26E−04 | −1.91E−04 | −6.00E−06 | 6.00E−06 | −4.00E−06 |
| S6 | −22.887 | −6.40E−01 | 3.71E−02 | 6.60E−05 | 6.28E−03 | −4.57E−04 | 9.54E−04 | 8.90E−05 | −9.90E−05 | 4.10E−05 |
| S7 | 0.429 | −2.29E+00 | 1.71E−01 | −2.53E−02 | 1.68E−02 | −3.65E−03 | 3.08E−03 | −8.64E−04 | −1.31E−04 | 7.00E−05 |
| S8 | −0.053 | 2.79E+00 | −1.26E−01 | 1.08E−01 | −8.90E−03 | 1.24E−02 | 6.62E−04 | −2.86E−04 | 2.70E−05 | 1.47E−04 |
| S9 | −2.148 | 8.66E−01 | −2.59E−01 | 9.14E−02 | −2.57E−02 | 1.60E−02 | −4.32E−03 | −5.90E−05 | −1.20E−04 | 1.96E−04 |
| S10 | 13.030 | −8.23E−01 | 1.14E−01 | −9.58E−03 | 1.35E−02 | −1.44E−04 | 4.05E−04 | −4.40E−04 | 5.23E−04 | 1.97E−04 |
| S11 | −51.566 | −2.28E−02 | 1.14E−01 | −8.94E−02 | 2.42E−02 | 5.25E−04 | −3.89E−03 | 2.76E−03 | −5.60E−04 | 1.36E−04 |
| S12 | −5.975 | −2.70E+00 | 3.88E−01 | −3.92E−02 | 4.22E−03 | 9.75E−03 | −1.65E−03 | 1.33E−03 | −6.10E−04 | 8.70E−05 |
| S13 | 5.399 | −2.70E+00 | 1.46E−01 | 4.07E−02 | −1.21E−02 | 3.99E−03 | 2.61E−03 | −6.45E−04 | −3.32E−04 | 8.80E−05 |
| S14 | −62.721 | −5.27E−01 | 3.69E−02 | −8.14E−03 | 1.22E−03 | −4.61E−04 | −2.65E−04 | 3.30E−05 | 1.09E−04 | 4.50E−05 |
| S15 | −38.113 | −7.92E−02 | 1.54E−02 | −4.41E−03 | 1.10E−03 | −5.20E−04 | −5.35E−04 | −1.10E−05 | 1.18E−04 | 4.60E−05 |
| S16 | −2.775 | 2.90E−01 | −4.89E−02 | 4.37E−03 | 1.30E−03 | −2.09E−03 | −1.60E−05 | 4.20E−05 | 2.09E−04 | −3.00E−05 |
| S17 | −48.555 | 1.84E−01 | −7.26E−02 | 1.14E−02 | −1.24E−03 | −1.23E−03 | 1.23E−04 | 1.50E−05 | 1.28E−04 | −4.60E−05 |

FIG. 10 illustrates a longitudinal aberration curve of the optical system 100 of Embodiment 2 in the short-focus state, and the longitudinal aberration curve represents deviations of focal points of light of different wavelengths after passing through the optical system 100. FIG. 11 illustrates an astigmatism curve of the optical system 100 of Embodiment 2 in the short-focus state, and the astigmatism curve represents meridianal image surface bending and sagittal image surface bending corresponding to different image heights. FIG. 12 illustrates a distortion curve of the optical system 100 of Embodiment 2 in the short-focus state, and the distortion curve represents distortion magnitudes corresponding to different image heights. It can be seen from FIG. 10, FIG. 11 and FIG. 12 that the optical system 100 of Embodiment 2 is able to achieve good imaging quality in the short-focus state.

### Embodiment 3

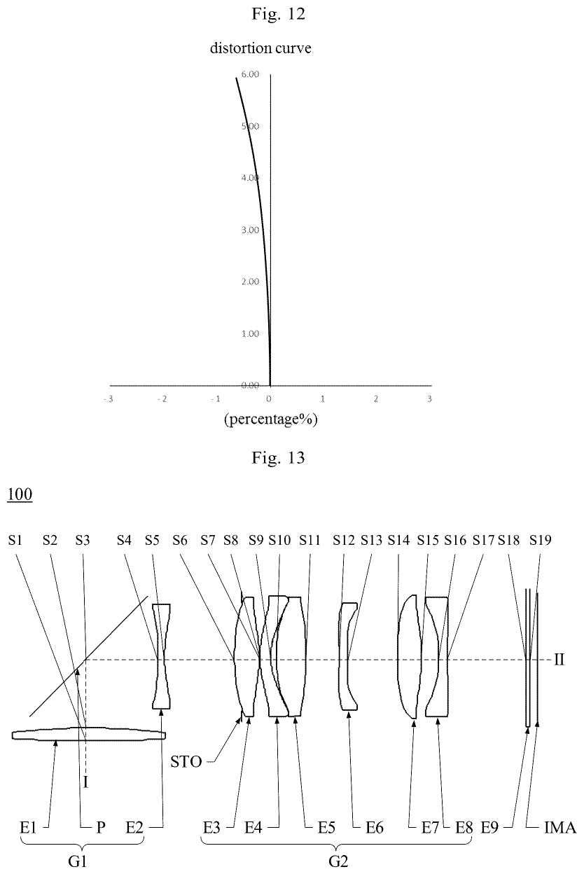

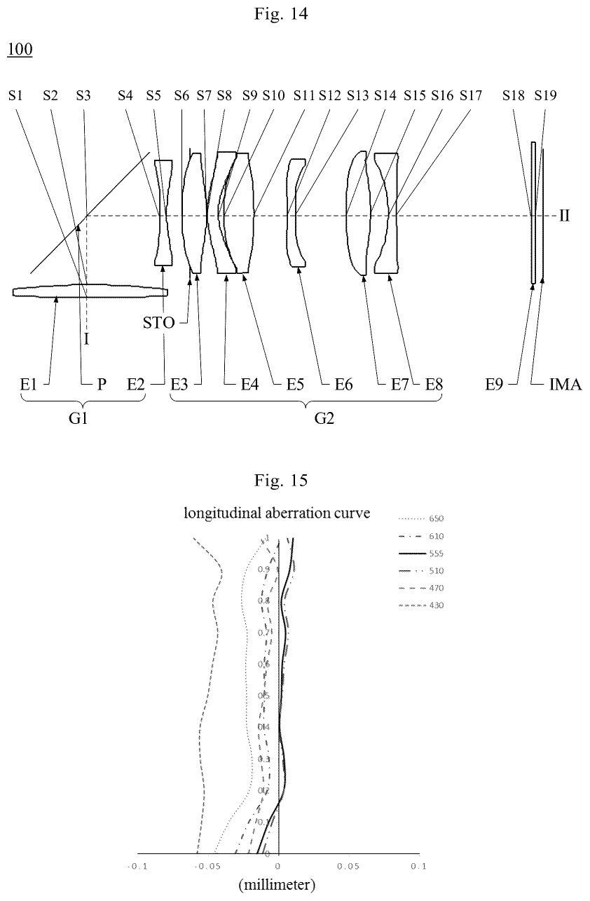

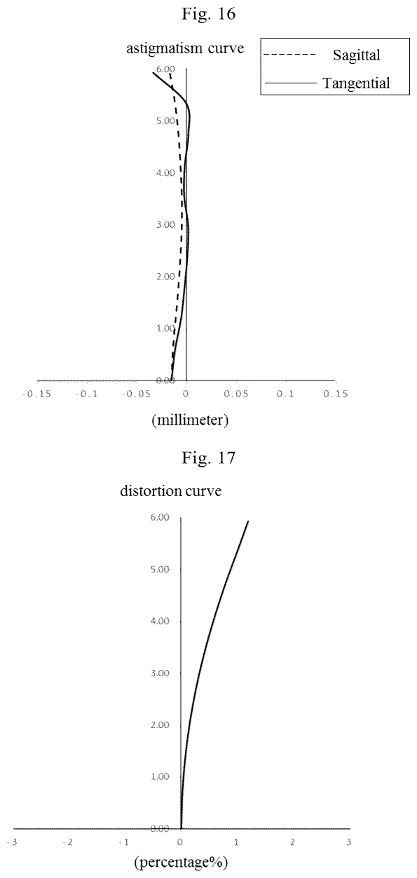

An optical system of Embodiment 3 is described below with reference to FIG. 13, FIG. 14, FIG. 15, FIG. 16 and FIG. 17. FIG. 13 illustrates a schematic structural diagram of the optical system in a short-focus state according to Embodiment 3 of the disclosure. FIG. 14 illustrates a schematic structural diagram of the optical system in a long-focus state according to Embodiment 3 of the disclosure.

As shown in FIG. 13 and FIG. 14, the optical system 100 includes a first element group G1 and a second element group G2, which are sequentially arranged from an object side to an image side. The image side is provided with an image surface IMA.

The first element group G1 includes a first lens E1, a reflective element P, and a second lens E2. The second element group G2 includes a third lens E3, a fourth lens E4, a fifth lens E5, a sixth lens E6, a seventh lens E7, and an eighth lens E8. The first lens E1 is located on an optical axis I and is disposed between the object side and the reflective element P. The second lens E2, the third lens E3, the fourth lens E4, the fifth lens E5, the sixth lens E6, the seventh lens E7 and the eighth lens E8 are sequentially arranged from the reflective element P to the image side along an optical axis II. An optical filter E9 is disposed between the eighth lens E8 and the image surface IMA. A diaphragm STO is disposed between the second lens E2 and the third lens E3.

The first lens E1 has a positive refractive power, an object-side surface S1 thereof is a convex surface, and an image-side surface S2 thereof is a convex surface. The reflective element P has a reflective surface S3, and the reflective surface S3 is a plane. The second lens E2 has a negative refractive power, an object-side surface S4 thereof is a convex surface, and an image-side surface S5 thereof is a concave surface. The third lens E3 has a positive refractive power, an object-side surface S6 thereof is a convex surface, and an image-side surface S7 thereof is a convex surface. The fourth lens E4 has a negative refractive power, an object-side surface S8 thereof is a convex surface, and an image-side surface S9 thereof is a concave surface. The fifth lens E5 has a positive refractive power, an object-side surface S10 thereof is a convex surface, and an image-side surface S11 thereof is a convex surface. The sixth lens E6 has a negative refractive power, an object-side surface S12 thereof is a concave surface, and an image-side surface S13 thereof is a convex surface. The seventh lens E7 has a positive refractive power, an object-side surface S14 thereof is a convex surface, and an image-side surface S15 thereof is a convex surface. The eighth lens E8 has a negative refractive power, an object-side surface S16 thereof is a concave surface, and an image-side surface S17 thereof is a concave surface. The optical filter E9 has an object-side surface S18 and an image-side surface S19. Light rays from an object sequentially pass through the surfaces S1 to S19 and are finally imaged on the image surface IMA.

Table 5 illustrates basic parameters of the optical system 100 of Embodiment 3, wherein the units of curvature radius and thickness/distance are millimeters (mm).

TABLE 5

| | | | | | | Material | | |
|---|---|---|---|---|---|---|---|---|
| Surface | | Surface | Curvature | Thickness/ | | Refractive | Abbe | Focal |
| number | Element | type | radius | distance | Material | index | number | length |
| S1 | First lens | Aspherical | 507.7148 | 1.1670 | Plastic | 1.650 | 21.798 | 66.74 |
| | | surface | | | | | | |
| S2 | | Aspherical | −47.8162 | 6.5880 | | | | |
| | | surface | | | | | | |
| S3 | Reflective | Spherical | Infinite | −6.4835 | | | | |
| | element | surface | | | | | | |
| S4 | Second lens | Aspherical | −190.8112 | −0.6634 | Plastic | 1.578 | 36.473 | −16.87 |
| | | surface | | | | | | |
| S5 | | Aspherical | −9.3074 | W1 | | | | |
| | | surface | | | | | | |
| STO | Aperture | Spherical | Infinite | 0.7489 | | | | |
| | | surface | | | | | | |
| S6 | Third lens | Aspherical | −19.1995 | −2.3606 | Plastic | 1.545 | 55.959 | 12.35 |
| | | surface | | | | | | |
| S7 | | Aspherical | 9.9626 | −0.0400 | | | | |
| | | surface | | | | | | |
| S8 | Fourth lens | Aspherical | −6.9762 | −1.0014 | Plastic | 1.657 | 20.383 | −21.69 |
| | | surface | | | | | | |
| S9 | | Aspherical | −4.4283 | −0.5558 | | | | |
| | | surface | | | | | | |
| S10 | Fifth lens | Aspherical | −19.1498 | −2.8000 | Plastic | 1.518 | 56.932 | 20.31 |
| | | surface | | | | | | |
| S11 | | Aspherical | 22.3174 | −3.1566 | | | | |
| | | surface | | | | | | |
| S12 | Sixth lens | Aspherical | 12.2200 | −0.7277 | Plastic | 1.623 | 25.643 | −32.57 |
| | | surface | | | | | | |
| S13 | | Aspherical | 31.0857 | −4.7371 | | | | |
| | | surface | | | | | | |
| S14 | Seventh lens | Aspherical | −47.0260 | −2.2727 | Plastic | 1.671 | 19.400 | 16.94 |
| | | surface | | | | | | |
| S15 | | Aspherical | 14.8920 | −1.6366 | | | | |
| | | surface | | | | | | |
| S16 | Eighth lens | Aspherical | 13.3673 | −0.7766 | Plastic | 1.545 | 55.959 | −15.46 |
| | | surface | | | | | | |
| S17 | | Aspherical | −23.4796 | W2 | | | | |
| | | surface | | | | | | |
| S18 | Optical filter | Spherical | Infinite | −0.2272 | Glass | 1.517 | 64.210 | |
| | | surface | | | | | | |
| S19 | | Spherical | Infinite | −0.5261 | | | | |
| | | surface | | | | | | |
| IMA | Image surface | Spherical | Infinite | | | | | |
| | | surface | | | | | | |

During the process of the optical system 100 switching from the short-focus state to the long-focus state, the position of the first element group G1 is fixed, and the second element group G2 moves towards the first element group G1 along the optical axis II. During the process of the optical system 100 switching from the long-focus state to the short-focus state, the position of the first element group G1 is fixed, the second element group G2 moves towards the image surface IMA along the optical axis II.

As shown in FIG. 13, when the optical system 100 is in the short-focus state, a spacing distance W1 between the first element group G1 and the second element group G2 (i.e., the image-side surface S5 of the second lens E2 and the object-side surface S6 of the third lens E3) on the optical axis II is 7.3343 mm, and a spacing distance W2 between the second element group G2 and the optical filter E9 (i.e., the image-side surface S17 of the eighth lens E8 and the object-side surface S18 of the optical filter E9) on the optical axis II is 7.4539 mm. At this time, an effective focal length EFL of the optical system 100 is 25.37 mm. As shown in FIG. 14, when the optical system 100 is in the long-focus state, the spacing distance W1 between the first element group G1 and the second element group G2 (i.e., the image-side surface S5 of the second lens E2 and the object-side surface S6 of the third lens E3) on the optical axis II is 2.1495 mm, and the spacing distance W2 between the second element group G2 and the optical filter E9 (i.e., the image-side surface S17 of the eighth lens E8 and the object-side surface S18 of the optical filter E9) on the optical axis II is 12.6386 mm. At this time, the effective focal length EFL of the optical system 100 is 38.00 mm.

In the present embodiment, the object-side surface and the image-side surface of any lens among the first lens E1 to the eighth lens E8 are aspherical surfaces. Table 6 shows conic coefficients K and high-order coefficients A₄, A₆, A₈, A₁₀, A₁₂, A₁₄, A₁₆, A₁₈ and A₂₀, which is applied to the aspherical surfaces S1-S2 and S4-S17 in Embodiment 3.

TABLE 6

| Surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | 74.283 | 5.85E−02 | 9.84E−04 | −2.56E−04 | −4.40E−05 | −1.30E−05 | −2.00E−06 | −1.00E−06 | −2.00E−06 | 2.00E−06 |
| S2 | −48.887 | −4.93E−03 | 4.09E−03 | −6.08E−04 | −6.00E−06 | −1.90E−05 | 0.00E+00 | −2.00E−06 | 0.00E+00 | 1.00E−06 |
| S4 | −75.481 | 5.24E−01 | −7.34E−02 | 1.40E−02 | −2.93E−03 | 6.48E−04 | −1.36E−04 | 2.60E−05 | 5.00E−06 | −5.00E−06 |
| S5 | −14.203 | 1.70E−01 | −3.62E−02 | 8.11E−03 | −1.85E−03 | 4.20E−04 | −8.70E−05 | 2.00E−05 | 6.00E−06 | −5.00E−06 |
| S6 | −24.993 | −3.09E−01 | 2.07E−02 | −5.42E−03 | 2.37E−03 | −4.44E−04 | 1.00E−06 | −1.88E−04 | −3.00E−06 | 1.60E−05 |
| S7 | 0.567 | −9.03E−01 | 7.58E−02 | −1.92E−02 | 5.22E−03 | −3.46E−04 | −4.59E−04 | −4.29E−04 | 1.54E−04 | 1.00E−05 |
| S8 | −0.049 | 1.34E+00 | −1.16E−01 | 3.05E−02 | −1.01E−02 | 4.80E−03 | −1.61E−03 | −2.22E−04 | 3.28E−04 | −3.80E−05 |
| S9 | −2.315 | 6.41E−01 | −1.44E−01 | 4.01E−02 | −1.45E−02 | 8.06E−03 | −3.14E−03 | 1.08E−03 | 5.56E−04 | −5.90E−05 |
| S10 | 5.780 | −4.33E−01 | 8.02E−02 | −2.04E−02 | 3.12E−03 | −3.70E−05 | −1.95E−03 | 1.02E−03 | 6.12E−04 | −6.90E−05 |
| S11 | −8.094 | −2.83E−02 | 2.76E−02 | −1.91E−02 | 2.12E−03 | −3.01E−03 | −9.69E−04 | 1.89E−04 | −9.50E−05 | −2.00E−05 |
| S12 | 1.083 | −1.33E+00 | 1.42E−01 | −3.01E−02 | 6.27E−03 | −3.35E−03 | 8.87E−04 | 3.29E−04 | −8.70E−05 | −1.00E−06 |
| S13 | −5.332 | −1.29E+00 | 1.00E−01 | −1.54E−02 | 4.01E−03 | −2.11E−03 | 3.45E−04 | 4.07E−04 | 3.00E−06 | −4.00E−06 |
| S14 | −50.785 | −5.61E−01 | −2.36E−02 | −4.11E−03 | 4.46E−04 | −1.14E−03 | −3.07E−04 | −1.28E−04 | −3.30E−05 | −1.50E−05 |
| S15 | −10.856 | −1.79E−01 | −3.40E−02 | −5.57E−03 | 1.33E−03 | −1.18E−03 | −4.68E−04 | −2.06E−04 | −9.00E−06 | −1.00E−05 |
| S16 | −17.506 | 7.12E−01 | −1.07E−01 | 1.49E−02 | −3.50E−04 | 1.38E−04 | 8.30E−05 | 7.50E−05 | 1.31E−04 | −1.00E−06 |
| S17 | −3.545 | 4.85E−01 | −9.68E−02 | 1.69E−02 | −1.79E−03 | 8.28E−04 | 1.41E−04 | 1.01E−04 | 7.60E−05 | −8.00E−06 |

FIG. 15 illustrates a longitudinal aberration curve of the optical system 100 of Embodiment 3 in the short-focus state, and the longitudinal aberration curve represents deviations of focal points of light of different wavelengths after passing through the optical system 100. FIG. 16 illustrates an astigmatism curve of the optical system 100 of Embodiment 3 in the short-focus state, and the astigmatism curve represents meridianal image surface bending and sagittal image surface bending corresponding to different image heights. FIG. 17 illustrates a distortion curve of the optical system 100 of Embodiment 3 in the short-focus state, and the distortion curve represents distortion magnitudes corresponding to different image heights. It can be seen from FIG. 15, FIG. 16 and FIG. 17 that the optical system 100 of Embodiment 3 is able to achieve good imaging quality in the short-focus state.

### Embodiment 4

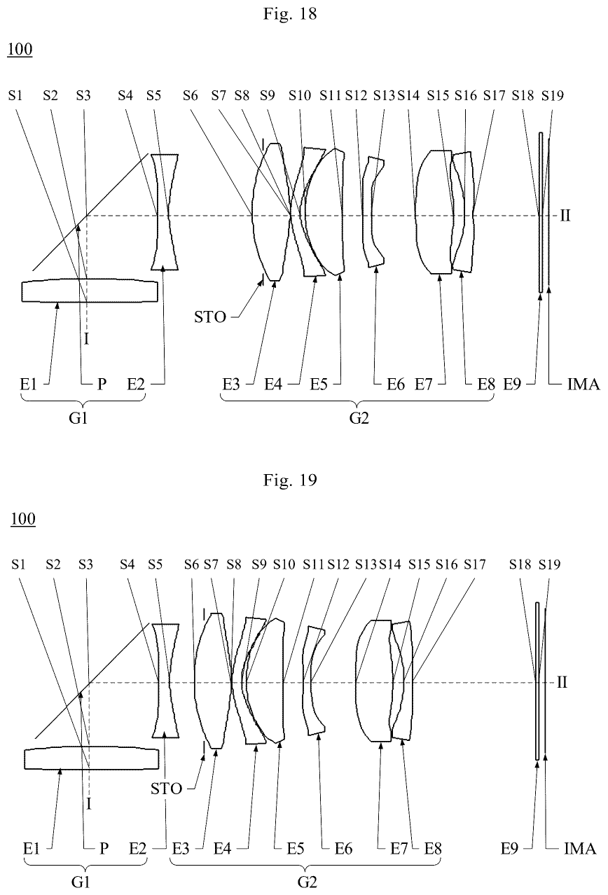

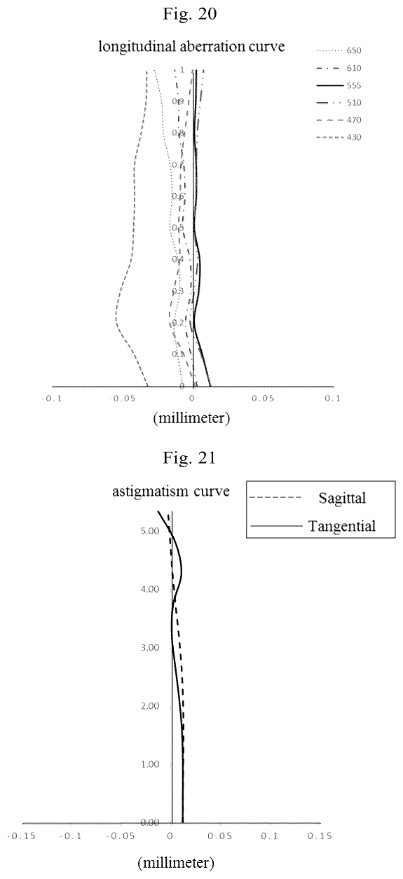

An optical system of Embodiment 4 is described below with reference to FIG. 18, FIG. 19, FIG. 20, FIG. 21 and FIG. 22. FIG. 18 illustrates a schematic structural diagram of the optical system in a short-focus state according to Embodiment 4 of the disclosure. FIG. 19 illustrates a schematic structural diagram of the optical system in a long-focus state according to Embodiment 4 of the disclosure.

As shown in FIG. 18 and FIG. 19, the optical system 100 includes a first element group G1 and a second element group G2, which are sequentially arranged from an object side to an image side. The image side is provided with an image surface IMA.

The first element group G1 includes a first lens E1, a reflective element P, and a second lens E2. The second element group G2 includes a third lens E3, a fourth lens E4, a fifth lens E5, a sixth lens E6, a seventh lens E7, and an eighth lens E8. The first lens E1 is located on an optical axis I and is disposed between the object side and the reflective element P. The second lens E2, the third lens E3, the fourth lens E4, the fifth lens E5, the sixth lens E6, the seventh lens E7 and the eighth lens E8 are sequentially arranged from the reflective element P to the image side along an optical axis II. An optical filter E9 is disposed between the eighth lens E8 and the image surface IMA. A diaphragm STO is disposed between the second lens E2 and the third lens E3.

The first lens E1 has a positive refractive power, an object-side surface S1 thereof is a convex surface, and an image-side surface S2 thereof is a convex surface. The reflective element P has a reflective surface S3, and the reflective surface S3 is a plane. The second lens E2 has a negative refractive power, an object-side surface S4 thereof is a convex surface, and an image-side surface S5 thereof is a concave surface. The third lens E3 has a positive refractive power, an object-side surface S6 thereof is a convex surface, and an image-side surface S7 thereof is a convex surface. The fourth lens E4 has a negative refractive power, an object-side surface S8 thereof is a convex surface, and an image-side surface S9 thereof is a concave surface. The fifth lens E5 has a positive refractive power, an object-side surface S10 thereof is a convex surface, and an image-side surface S11 thereof is a concave surface. The sixth lens E6 has a negative refractive power, an object-side surface S12 thereof is a concave surface, and an image-side surface S13 thereof is a convex surface. The seventh lens E7 has a positive refractive power, an object-side surface S14 thereof is a convex surface, and an image-side surface S15 thereof is a convex surface. The eighth lens E8 has a negative refractive power, an object-side surface S16 thereof is a concave surface, and an image-side surface S17 thereof is a concave surface. The optical filter E9 has an object-side surface S18 and an image-side surface S19. Light rays from an object sequentially pass through the surfaces S1 to S19 and are finally imaged on the image surface IMA.

Table 7 illustrates basic parameters of the optical system 100 of Embodiment 4, wherein the units of curvature radius and thickness/distance are millimeters (mm).

TABLE 7

| | | | | | | Material | | |
|---|---|---|---|---|---|---|---|---|
| Surface | | Surface | Curvature | Thickness/ | | Refractive | Abbe | Focal |
| number | Element | type | radius | distance | Material | index | number | length |
| S1 | First lens | Aspherical | 5081.0354 | 1.7223 | Plastic | 1.671 | 19.400 | 57.32 |
| | | surface | | | | | | |
| S2 | | Aspherical | −39.1312 | 4.8214 | | | | |
| | | surface | | | | | | |
| S3 | Reflective | Spherical | Infinite | −5.0155 | | | | |
| | element | surface | | | | | | |
| S4 | Second lens | Aspherical | −96.6599 | −0.7835 | Plastic | 1.570 | 39.482 | −12.51 |
| | | surface | | | | | | |
| S5 | | Aspherical | −6.6505 | W1 | | | | |
| | | surface | | | | | | |
| STO | Aperture | Spherical | Infinite | 0.7740 | | | | |
| | | surface | | | | | | |
| S6 | Third lens | Aspherical | −11.3985 | −2.8000 | Plastic | 1.542 | 56.053 | 8.59 |
| | | surface | | | | | | |
| S7 | | Aspherical | 7.2277 | −0.0400 | | | | |
| | | surface | | | | | | |
| S8 | Fourth lens | Aspherical | −4.4597 | −0.6864 | Plastic | 1.671 | 19.459 | −15.50 |
| | | surface | | | | | | |
| S9 | | Aspherical | −2.9351 | −0.3872 | | | | |
| | | surface | | | | | | |
| S10 | Fifth lens | Aspherical | −9.2660 | −2.7467 | Plastic | 1.516 | 56.999 | 18.71 |
| | | surface | | | | | | |
| S11 | | Aspherical | −192.5130 | −1.5281 | | | | |
| | | surface | | | | | | |
| S12 | Sixth lens | Aspherical | 11.3087 | −0.6001 | Plastic | 1.604 | 29.125 | −29.48 |
| | | surface | | | | | | |
| S13 | | Aspherical | 31.2623 | −3.2857 | | | | |
| | | surface | | | | | | |
| S14 | Seventh lens | Aspherical | −52.6949 | −2.8000 | Plastic | 1.671 | 19.400 | 13.89 |
| | | surface | | | | | | |
| S15 | | Aspherical | 11.2091 | −0.8154 | | | | |
| | | surface | | | | | | |
| S16 | Eighth lens | Aspherical | 10.9573 | −0.6401 | Plastic | 1.545 | 55.959 | −13.37 |
| | | surface | | | | | | |
| S17 | | Aspherical | −22.4305 | W2 | | | | |
| | | surface | | | | | | |
| S18 | Optical filter | Spherical | Infinite | −0.2039 | Glass | 1.517 | 64.210 | |
| | | surface | | | | | | |
| S19 | | Spherical | Infinite | −0.4722 | | | | |
| | | surface | | | | | | |
| IMA | Image surface | Spherical | Infinite | | | | | |
| | | surface | | | | | | |

During the process of the optical system 100 switching from the short-focus state to the long-focus state, the position of the first element group G1 is fixed, and the second element group G2 moves towards the first element group G1 along the optical axis II. During the process of the optical system 100 switching from the long-focus state to the short-focus state, the position of the first element group G1 is fixed, the second element group G2 moves towards the image surface IMA along the optical axis II.

As shown in FIG. 18, when the optical system 100 is in the short-focus state, a spacing distance W1 between the first element group G1 and the second element group G2 (i.e., the image-side surface S5 of the second lens E2 and the object-side surface S6 of the third lens E3) on the optical axis II is 6.9634 mm, and a spacing distance W2 between the second element group G2 and the optical filter E9 (i.e., the image-side surface S17 of the eighth lens E8 and the object-side surface S18 of the optical filter E9) on the optical axis II is 4.9042 mm. At this time, an effective focal length EFL of the optical system 100 is 16.60 mm. As shown in FIG. 19, when the optical system 100 is in the long-focus state, the spacing distance W1 between the first element group G1 and the second element group G2 (i.e., the image-side surface S5 of the second lens E2 and the object-side surface S6 of the third lens E3) on the optical axis II is 2.6090 mm, and the spacing distance W2 between the second element group G2 and the optical filter E9 (i.e., the image-side surface S17 of the eighth lens E8 and the object-side surface S18 of the optical filter E9) on the optical axis II is 9.2585 mm. At this time, the effective focal length EFL of the optical system 100 is 26.10 mm.

In the present embodiment, the object-side surface and the image-side surface of any lens among the first lens E1 to the eighth lens E8 are aspherical surfaces. Table 8 shows conic coefficients K and high-order coefficients A₄, A₆, A₈, A₁₀, A₁₂, A₁₄, A₁₆, A₁₈ and A₂₀, which is applied to the aspherical surfaces S1-S2 and S4-S17 in Embodiment 4.

TABLE 8

| Surface | | | | | | | | | | |
|---|---|---|---|---|---|---|---|---|---|---|
| number | A₄ | A₆ | A₈ | A₁₀ | A₁₂ | A₁₄ | A₁₆ | A₁₈ | A₂₀ | A₄ |
| S1 | 90.000 | 4.23E−01 | 2.74E−02 | 6.58E−03 | 2.39E−03 | 1.18E−04 | 1.60E−05 | −3.40E−05 | −1.70E−05 | 2.40E−05 |
| S2 | −61.768 | 6.27E−02 | 5.64E−02 | −2.16E−03 | 3.55E−03 | −4.33E−04 | 1.03E−04 | −5.80E−05 | −2.00E−06 | 2.40E−05 |
| S4 | 74.135 | 8.82E−01 | −1.38E−01 | 3.01E−02 | −7.48E−03 | 1.87E−03 | −4.79E−04 | 1.09E−04 | −2.60E−05 | 8.00E−06 |
| S5 | −11.974 | 1.46E−01 | −3.44E−02 | 7.86E−03 | −1.77E−03 | 2.85E−04 | −2.40E−05 | −3.30E−05 | 1.20E−05 | −5.00E−06 |
| S6 | −10.451 | −3.91E−01 | 2.69E−02 | −7.17E−03 | 1.78E−03 | 2.31E−04 | 2.45E−04 | 8.00E−06 | −3.90E−05 | 2.40E−05 |
| S7 | 0.667 | −1.24E+00 | 1.15E−01 | −4.48E−02 | 1.35E−02 | −2.82E−03 | 1.44E−03 | −5.97E−04 | 1.17E−04 | 7.00E−06 |
| S8 | −0.081 | 1.94E+00 | −4.07E−02 | 5.92E−02 | 3.55E−03 | 6.55E−03 | 1.01E−03 | −2.39E−04 | 1.89E−04 | 1.10E−04 |
| S9 | −2.280 | 4.14E−01 | −1.15E−01 | 4.14E−02 | −4.91E−03 | 6.13E−03 | −1.83E−03 | −1.40E−03 | 1.37E−04 | 1.69E−04 |
| S10 | 2.466 | −4.08E−01 | 9.24E−02 | −2.93E−02 | 1.17E−02 | −2.24E−03 | −7.87E−04 | −1.54E−03 | 3.78E−04 | 1.18E−04 |
| S11 | 90.000 | −1.88E−02 | −2.48E−02 | −1.93E−02 | 3.02E−03 | −2.33E−03 | −6.30E−05 | 7.60E−05 | −9.10E−05 | −4.40E−05 |
| S12 | 1.406 | −1.14E+00 | 1.27E−01 | −1.07E−02 | 4.78E−03 | −1.12E−03 | 4.97E−04 | 1.15E−04 | −3.90E−05 | 1.30E−05 |
| S13 | 1.877 | −1.26E+00 | 8.68E−02 | 1.54E−03 | 1.48E−03 | −6.65E−04 | 2.07E−04 | 1.26E−04 | −3.40E−05 | −8.00E−06 |
| S14 | −37.128 | −6.37E−01 | −4.43E−03 | −6.26E−04 | −2.65E−04 | −1.40E−05 | 4.90E−05 | 4.00E−07 | −5.00E−06 | 0.00E+00 |
| S15 | −9.700 | −3.19E−01 | −6.49E−02 | −7.24E−03 | −3.12E−03 | −2.46E−04 | 3.70E−05 | 9.00E−05 | 2.30E−05 | −3.00E−06 |
| S16 | −40.992 | 6.57E−01 | −1.88E−01 | 2.55E−02 | −1.10E−02 | 2.33E−03 | −6.29E−04 | 2.38E−04 | −5.40E−05 | −1.00E−06 |
| S17 | 24.018 | 7.14E−01 | −1.08E−01 | 3.21E−02 | −6.68E−03 | 3.04E−03 | −5.83E−04 | 2.75E−04 | −6.70E−05 | 2.00E−05 |

FIG. 20 illustrates a longitudinal aberration curve of the optical system 100 of Embodiment 4 in the short-focus state, and the longitudinal aberration curve represents deviations of focal points of light of different wavelengths after passing through the optical system 100. FIG. 21 illustrates an astigmatism curve of the optical system 100 of Embodiment 4 in the short-focus state, and the astigmatism curve represents meridianal image surface bending and sagittal image surface bending corresponding to different image heights. FIG. 22 illustrates a distortion curve of the optical system 100 of Embodiment 4 in the short-focus state, and the distortion curve represents distortion magnitudes corresponding to different image heights. It can be seen from FIG. 20, FIG. 21 and FIG. 22 that the optical system 100 of Embodiment 4 is able to achieve good imaging quality in the short-focus state.

### Embodiment 5

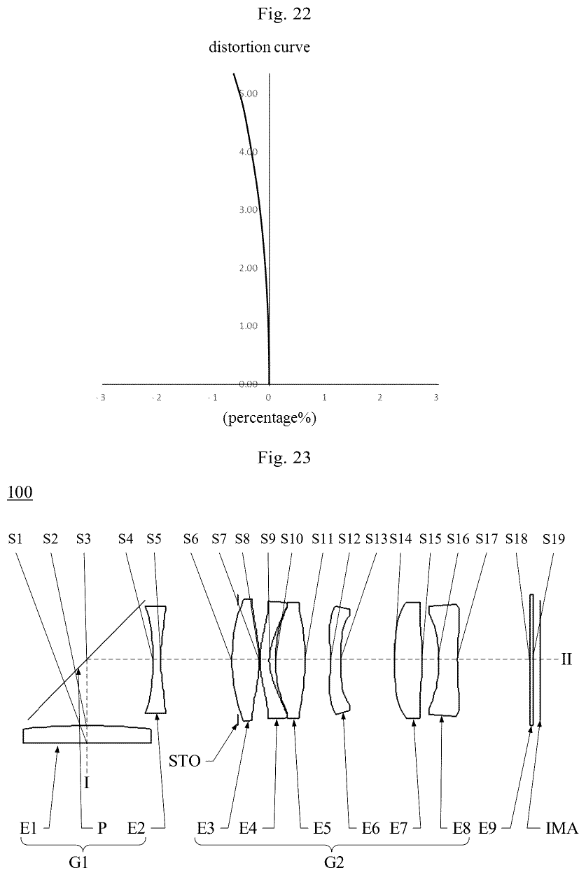

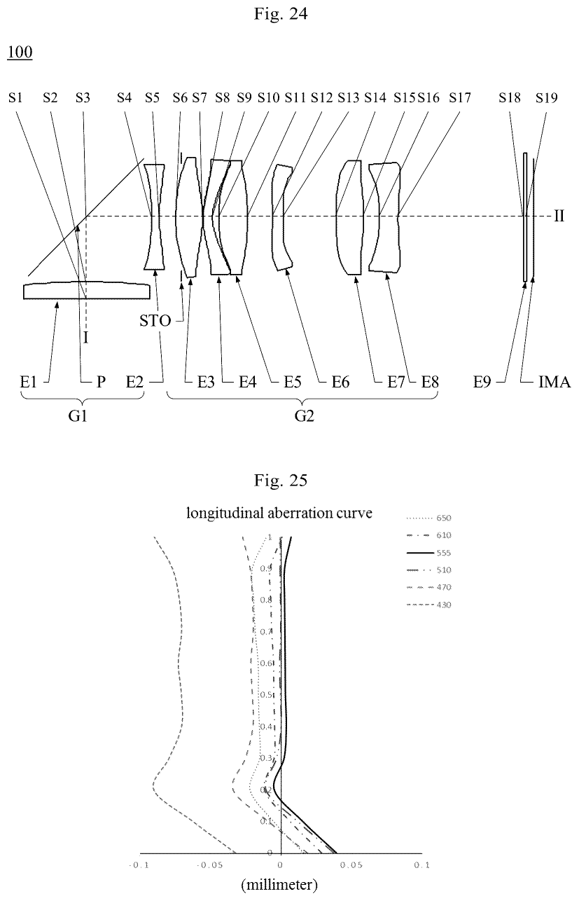

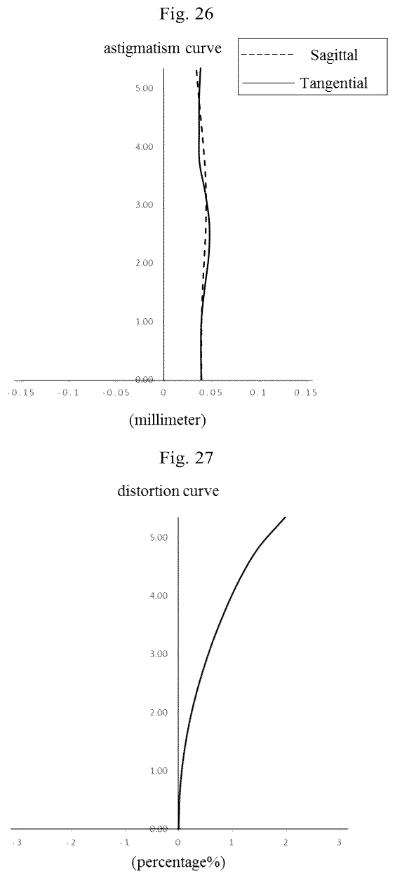

An optical system of Embodiment 5 is described below with reference to FIG. 23, FIG. 24, FIG. 25, FIG. 26 and FIG. 27. FIG. 23 illustrates a schematic structural diagram of the optical system in a short-focus state according to Embodiment 5 of the disclosure. FIG. 24 illustrates a schematic structural diagram of the optical system in a long-focus state according to Embodiment 5 of the disclosure.

As shown in FIG. 23 and FIG. 24, the optical system 100 includes a first element group G1 and a second element group G2, which are sequentially arranged from an object side to an image side. The image side is provided with an image surface IMA.

The first element group G1 includes a first lens E1, a reflective element P, and a second lens E2. The second element group G2 includes a third lens E3, a fourth lens E4, a fifth lens E5, a sixth lens E6, a seventh lens E7, and an eighth lens E8. The first lens E1 is located on an optical axis I and is disposed between the object side and the reflective element P. The second lens E2, the third lens E3, the fourth lens E4, the fifth lens E5, the sixth lens E6, the seventh lens E7 and the eighth lens E8 are sequentially arranged from the reflective element P to the image side along an optical axis II. An optical filter E9 is disposed between the eighth lens E8 and the image surface IMA. A diaphragm STO is disposed between the second lens E2 and the third lens E3.

The first lens E1 has a positive refractive power, an object-side surface S1 thereof is a convex surface, and an image-side surface S2 thereof is a convex surface. The reflective element P has a reflective surface S3, and the reflective surface S3 is a plane. The second lens E2 has a negative refractive power, an object-side surface S4 thereof is a convex surface, and an image-side surface S5 thereof is a concave surface. The third lens E3 has a positive refractive power, an object-side surface S6 thereof is a convex surface, and an image-side surface S7 thereof is a convex surface. The fourth lens E4 has a negative refractive power, an object-side surface S8 thereof is a convex surface, and an image-side surface S9 thereof is a concave surface. The fifth lens E5 has a positive refractive power, an object-side surface S10 thereof is a convex surface, and an image-side surface S11 thereof is a convex surface. The sixth lens E6 has a negative refractive power, an object-side surface S12 thereof is a concave surface, and an image-side surface S13 thereof is a convex surface. The seventh lens E7 has a positive refractive power, an object-side surface S14 thereof is a convex surface, and an image-side surface S15 thereof is a convex surface. The eighth lens E8 has a negative refractive power, an object-side surface S16 thereof is a concave surface, and an image-side surface S17 thereof is a concave surface. The optical filter E9 has an object-side surface S18 and an image-side surface S19. Light rays from an object sequentially pass through the surfaces S1 to S19 and are finally imaged on the image surface IMA.

Table 9 illustrates basic parameters of the optical system 100 of Embodiment 5, wherein the units of curvature radius and thickness/distance are millimeters (mm).

TABLE 9

| | | | | | | Material | | |
|---|---|---|---|---|---|---|---|---|
| Surface | | Surface | Curvature | Thickness/ | | Refractive | Abbe | Focal |
| number | Element | type | radius | distance | Material | index | number | length |
| S1 | First lens | Aspherical | 12403.8818 | 1.5848 | Plastic | 1.611 | 24.720 | 87.04 |
| | | surface | | | | | | |
| S2 | | Aspherical | −53.8307 | 5.8467 | | | | |
| | | surface | | | | | | |
| S3 | Reflective | Spherical | Infinite | −5.9377 | | | | |
| | element | surface | | | | | | |
| S4 | Second lens | Aspherical | −244.6832 | −0.7165 | Plastic | 1.545 | 55.503 | −18.16 |
| | | surface | | | | | | |
| S5 | | Aspherical | −9.5424 | W1 | | | | |
| | | surface | | | | | | |
| STO | Aperture | Spherical | Infinite | 0.5443 | | | | |
| | | surface | | | | | | |
| S6 | Third lens | Aspherical | −17.7726 | −2.4661 | Plastic | 1.539 | 56.157 | 11.08 |
| | | surface | | | | | | |
| S7 | | Aspherical | 8.5970 | −0.0400 | | | | |
| | | surface | | | | | | |
| S8 | Fourth lens | Aspherical | −6.3667 | −0.8682 | Plastic | 1.635 | 23.435 | −19.25 |
| | | surface | | | | | | |
| S9 | | Aspherical | −3.9736 | −0.5880 | | | | |
| | | surface | | | | | | |
| S10 | Fifth lens | Aspherical | −18.4334 | −2.6490 | Plastic | 1.516 | 56.999 | 18.03 |
| | | surface | | | | | | |
| S11 | | Aspherical | 17.9804 | −2.3057 | | | | |
| | | surface | | | | | | |
| S12 | Sixth lens | Aspherical | 10.2069 | −0.9833 | Plastic | 1.639 | 23.333 | −26.35 |
| | | surface | | | | | | |
| S13 | | Aspherical | 26.5785 | −4.8216 | | | | |
| | | surface | | | | | | |
| S14 | Seventh lens | Aspherical | −36.1714 | −2.5094 | Plastic | 1.671 | 19.400 | 21.59 |
| | | surface | | | | | | |
| S15 | | Aspherical | 23.8810 | −1.4951 | | | | |
| | | surface | | | | | | |
| S16 | Eighth lens | Aspherical | 17.5242 | −1.7169 | Plastic | 1.545 | 55.959 | −17.87 |
| | | surface | | | | | | |
| S17 | | Aspherical | −22.8557 | W2 | | | | |
| | | surface | | | | | | |
| S18 | Optical filter | Spherical | Infinite | −0.2795 | Glass | 1.517 | 64.210 | |
| | | surface | | | | | | |
| S19 | | Spherical | Infinite | −0.6474 | | | | |
| | | surface | | | | | | |
| IMA | Image surface | Spherical | Infinite | | | | | |
| | | surface | | | | | | |

During the process of the optical system 100 switching from the short-focus state to the long-focus state, the position of the first element group G1 is fixed, and the second element group G2 moves towards the first element group G1 along the optical axis II. During the process of the optical system 100 switching from the long-focus state to the short-focus state, the position of the first element group G1 is fixed, the second element group G2 moves towards the image surface IMA along the optical axis II.

As shown in FIG. 23, when the optical system 100 is in the short-focus state, a spacing distance W1 between the first element group G1 and the second element group G2 (i.e., the image-side surface S5 of the second lens E2 and the object-side surface S6 of the third lens E3) on the optical axis II is 7.0500 mm, and a spacing distance W2 between the second element group G2 and the optical filter E9 (i.e., the image-side surface S17 of the eighth lens E8 and the object-side surface S18 of the optical filter E9) on the optical axis II is 6.5703 mm. At this time, an effective focal length EFL of the optical system 100 is 22.76 mm. As shown in FIG. 24, when the optical system 100 is in the long-focus state, the spacing distance W1 between the first element group G1 and the second element group G2 (i.e., the image-side surface S5 of the second lens E2 and the object-side surface S6 of the third lens E3) on the optical axis II is 2.0921 mm, and the spacing distance W2 between the second element group G2 and the optical filter E9 (i.e., the image-side surface S17 of the eighth lens E8 and the object-side surface S18 of the optical filter E9) on the optical axis II is 11.5282 mm. At this time, the effective focal length EFL of the optical system 100 is 34.13 mm.

In the present embodiment, the object-side surface and the image-side surface of any lens among the first lens E1 to the eighth lens E8 are aspherical surfaces. Table 10 shows conic coefficients K and high-order coefficients A₄, A₆, A₈, A₁₀, A₁₂, A₁₄, A₁₆, A₁₈ and A₂₀, which is applied to the aspherical surfaces S1-S2 and S4-S17 in Embodiment 5.

TABLE 10

| Surface | | | | | | | | | | |
|---|---|---|---|---|---|---|---|---|---|---|
| number | A₄ | A₆ | A₈ | A₁₀ | A₁₂ | A₁₄ | A₁₆ | A₁₈ | A₂₀ | A₄ |
| S1 | 90.000 | 3.08E−01 | 3.84E−02 | 1.31E−02 | −6.38E−04 | −3.11E−03 | −8.21E−04 | 5.80E−05 | 2.77E−04 | 8.50E−05 |
| S2 | −49.407 | 4.40E−02 | 4.44E−02 | 9.20E−03 | −1.11E−03 | −3.20E−03 | −6.90E−04 | 1.21E−04 | 3.09E−04 | 9.30E−05 |
| S4 | −89.882 | 9.52E−01 | −1.42E−01 | 3.21E−02 | −5.88E−03 | 2.37E−03 | −2.26E−04 | 1.21E−04 | −3.70E−05 | −2.00E−06 |
| S5 | −16.589 | 3.49E−01 | −6.88E−02 | 1.78E−02 | −2.77E−03 | 1.52E−03 | −2.00E−05 | 4.80E−05 | −3.90E−05 | −1.80E−05 |
| S6 | −27.407 | −3.65E−01 | 2.44E−02 | −7.13E−03 | 1.96E−03 | −7.70E−05 | 6.20E−05 | −3.30E−05 | 2.50E−05 | −1.10E−05 |
| S7 | 0.560 | −1.06E+00 | 8.27E−02 | −2.54E−02 | 6.40E−03 | −5.90E−05 | −4.37E−04 | 1.11E−04 | 2.10E−05 | −3.00E−06 |
| S8 | −0.056 | 1.39E+00 | −1.16E−01 | 3.17E−02 | −9.33E−03 | 5.13E−03 | −1.92E−03 | 3.05E−04 | 1.90E−05 | 1.20E−05 |
| S9 | −2.290 | 6.15E−01 | −1.40E−01 | 4.15E−02 | −1.43E−02 | 7.85E−03 | −3.74E−03 | 1.14E−03 | 3.33E−04 | 1.14E−04 |
| S10 | 5.529 | −4.11E−01 | 7.53E−02 | −1.88E−02 | 3.98E−03 | 1.11E−03 | −1.96E−03 | 8.41E−04 | 4.83E−04 | 6.70E−05 |
| S11 | −6.876 | −1.71E−02 | 2.84E−02 | −1.75E−02 | 4.61E−03 | −1.53E−03 | −3.00E−04 | 2.93E−04 | −1.50E−04 | −1.90E−05 |
| S12 | 0.792 | −1.41E+00 | 1.51E−01 | −3.03E−02 | 6.96E−03 | −2.03E−03 | 3.95E−04 | −9.30E−05 | −1.17E−04 | 1.30E−05 |
| S13 | 9.265 | −1.22E+00 | 9.37E−02 | −1.37E−02 | 2.41E−03 | −5.57E−04 | 8.90E−05 | −3.40E−05 | −1.08E−04 | −1.40E−05 |
| S14 | −89.362 | −5.02E−01 | −1.33E−02 | 2.83E−03 | −7.09E−04 | 8.82E−04 | −1.24E−04 | −2.78E−04 | −1.00E−04 | −1.20E−05 |
| S15 | −11.276 | −2.02E−01 | −3.47E−02 | 4.71E−03 | −3.88E−03 | 1.74E−03 | 1.62E−04 | −2.41E−04 | −1.19E−04 | −2.00E−06 |
| S16 | −26.859 | 5.69E−01 | −6.02E−02 | 3.12E−03 | −7.24E−03 | 2.89E−03 | 2.61E−04 | 1.78E−04 | 1.27E−04 | 9.60E−05 |
| S17 | −1.917 | 4.09E−01 | −4.93E−02 | 9.95E−04 | −3.53E−03 | 1.71E−03 | 7.40E−05 | 3.63E−04 | 1.93E−04 | 1.01E−04 |

FIG. 25 illustrates a longitudinal aberration curve of the optical system 100 of Embodiment 5 in the short-focus state, and the longitudinal aberration curve represents deviations of focal points of light of different wavelengths after passing through the optical system 100. FIG. 26 illustrates an astigmatism curve of the optical system 100 of Embodiment 5 in the short-focus state, and the astigmatism curve represents meridianal image surface bending and sagittal image surface bending corresponding to different image heights. FIG. 27 illustrates a distortion curve of the optical system 100 of Embodiment 5 in the short-focus state, and the distortion curve represents distortion magnitudes corresponding to different image heights. It can be seen from FIG. 25, FIG. 26 and FIG. 27 that the optical system 100 of Embodiment 5 is able to achieve good imaging quality in the short-focus state.

### Embodiment 6

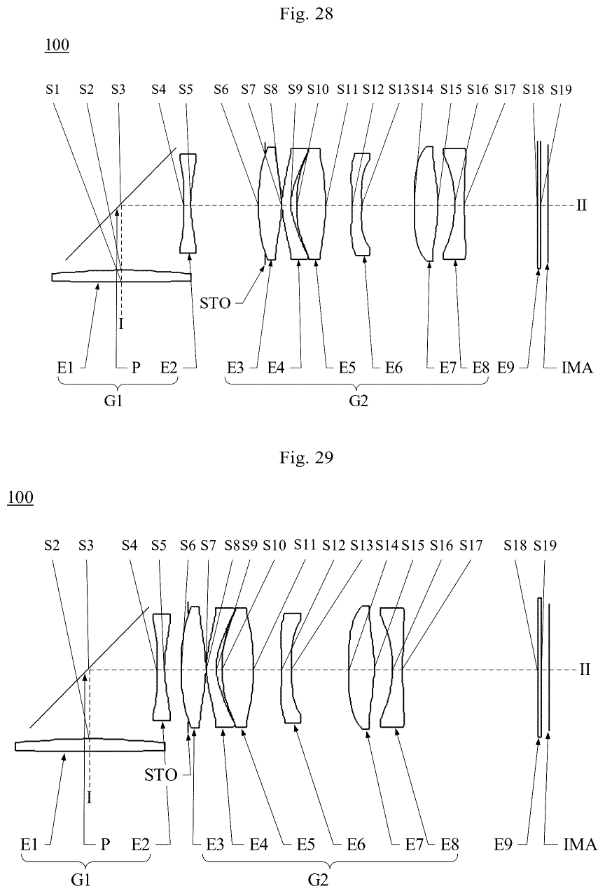

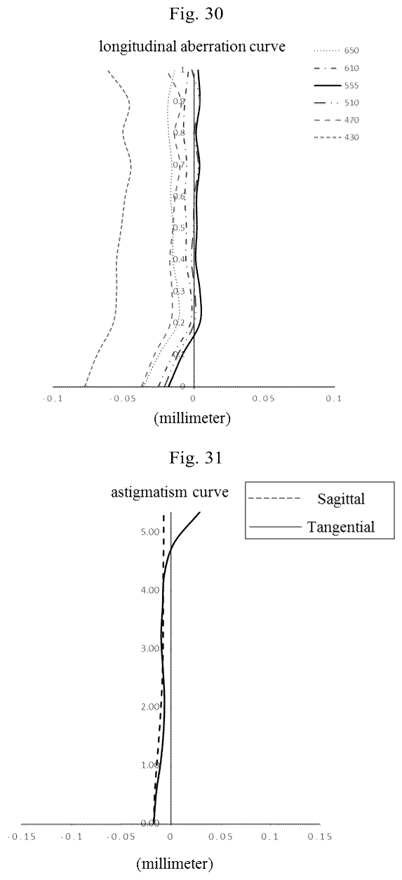

An optical system of Embodiment 6 is described below with reference to FIG. 28, FIG. 29, FIG. 30, FIG. 31 and FIG. 32. FIG. 28 illustrates a schematic structural diagram of the optical system in a short-focus state according to Embodiment 6 of the disclosure. FIG. 29 illustrates a schematic structural diagram of the optical system in a long-focus state according to Embodiment 26 of the disclosure.

As shown in FIG. 28 and FIG. 29, the optical system 100 includes a first element group G1 and a second element group G2, which are sequentially arranged from an object side to an image side. The image side is provided with an image surface IMA.

The first element group G1 includes a first lens E1, a reflective element P, and a second lens E2. The second element group G2 includes a third lens E3, a fourth lens E4, a fifth lens E5, a sixth lens E6, a seventh lens E7, and an eighth lens E8. The first lens E1 is located on an optical axis I and is disposed between the object side and the reflective element P. The second lens E2, the third lens E3, the fourth lens E4, the fifth lens E5, the sixth lens E6, the seventh lens E7 and the eighth lens E8 are sequentially arranged from the reflective element P to the image side along an optical axis II. An optical filter E9 is disposed between the eighth lens E8 and the image surface IMA. A diaphragm STO is disposed between the second lens E2 and the third lens E3.

The first lens E1 has a positive refractive power, an object-side surface S1 thereof is a convex surface, and an image-side surface S2 thereof is a convex surface. The reflective element P has a reflective surface S3, and the reflective surface S3 is a plane. The second lens E2 has a negative refractive power, an object-side surface S4 thereof is a convex surface, and an image-side surface S5 thereof is a concave surface. The third lens E3 has a positive refractive power, an object-side surface S6 thereof is a convex surface, and an image-side surface S7 thereof is a convex surface. The fourth lens E4 has a negative refractive power, an object-side surface S8 thereof is a convex surface, and an image-side surface S9 thereof is a concave surface. The fifth lens E5 has a positive refractive power, an object-side surface S10 thereof is a convex surface, and an image-side surface S11 thereof is a convex surface. The sixth lens E6 has a negative refractive power, an object-side surface S12 thereof is a concave surface, and an image-side surface S13 thereof is a convex surface. The seventh lens E7 has a positive refractive power, an object-side surface S14 thereof is a convex surface, and an image-side surface S15 thereof is a convex surface. The eighth lens E8 has a negative refractive power, an object-side surface S16 thereof is a concave surface, and an image-side surface S17 thereof is a concave surface. The optical filter E9 has an object-side surface S18 and an image-side surface S19. Light rays from an object sequentially pass through the surfaces S1 to S19 and are finally imaged on the image surface IMA.

Table 11 illustrates basic parameters of the optical system 100 of Embodiment 6, wherein the units of curvature radius and thickness/distance are millimeters (mm).

TABLE 11

| | | | | | | Material | | |
|---|---|---|---|---|---|---|---|---|
| Surface | | Surface | Curvature | Thickness/ | | Refractive | Abbe | Focal |
| number | Element | type | radius | distance | Material | index | number | length |
| S1 | First lens | Aspherical | 328.5229 | 1.0823 | Plastic | 1.664 | 19.879 | 64.16 |
| | | surface | | | | | | |
| S2 | | Aspherical | −49.4020 | 5.9570 | | | | |
| | | surface | | | | | | |
| S3 | Reflective | Spherical | Infinite | −5.7644 | | | | |
| | element | surface | | | | | | |
| S4 | Second lens | Aspherical | −165.6767 | −0.6100 | Plastic | 1.569 | 37.038 | −15.72 |
| | | surface | | | | | | |
| S5 | | Aspherical | −8.5113 | W1 | | | | |
| | | surface | | | | | | |
| STO | Aperture | Spherical | Infinite | 0.6704 | | | | |
| | | surface | | | | | | |
| S6 | Third lens | Aspherical | −17.4512 | −2.1475 | Plastic | 1.544 | 55.983 | 11.08 |
| | | surface | | | | | | |
| S7 | | Aspherical | 8.8585 | −0.0400 | | | | |
| | | surface | | | | | | |
| S8 | Fourth lens | Aspherical | −6.2767 | −0.8195 | Plastic | 1.644 | 21.379 | −19.24 |
| | | surface | | | | | | |
| S9 | | Aspherical | −3.9637 | −0.5281 | | | | |
| | | surface | | | | | | |
| S10 | Fifth lens | Aspherical | −17.5099 | −2.6515 | Plastic | 1.516 | 56.998 | 17.15 |
| | | surface | | | | | | |
| S11 | | Aspherical | 17.0930 | −2.4541 | | | | |
| | | surface | | | | | | |
| S12 | Sixth lens | Aspherical | 10.0294 | −0.8475 | Plastic | 1.625 | 25.384 | −25.45 |
| | | surface | | | | | | |
| S13 | | Aspherical | 27.7023 | −4.8110 | | | | |
| | | surface | | | | | | |
| S14 | Seventh lens | Aspherical | −49.3784 | −2.1673 | Plastic | 1.671 | 19.400 | 15.73 |
| | | surface | | | | | | |
| S15 | | Aspherical | 13.3489 | −1.5456 | | | | |
| | | surface | | | | | | |
| S16 | Eighth lens | Aspherical | 13.1009 | −0.8740 | Plastic | 1.545 | 55.959 | −14.48 |
| | | surface | | | | | | |
| S17 | | Aspherical | −20.4961 | W2 | | | | |
| | | surface | | | | | | |
| S18 | Optical filter | Spherical | Infinite | −0.2795 | Glass | 1.517 | 64.210 | |
| | | surface | | | | | | |
| S19 | | Spherical | Infinite | −0.6474 | | | | |
| | | surface | | | | | | |
| IMA | Image surface | Spherical | Infinite | | | | | |
| | | surface | | | | | | |

During the process of the optical system 100 switching from the short-focus state to the long-focus state, the position of the first element group G1 is fixed, and the second element group G2 moves towards the first element group G1 along the optical axis II. During the process of the optical system 100 switching from the long-focus state to the short-focus state, the position of the first element group G1 is fixed, the second element group G2 moves towards the image surface IMA along the optical axis II.

As shown in FIG. 28, when the optical system 100 is in the short-focus state, a spacing distance W1 between the first element group G1 and the second element group G2 (i.e., the image-side surface S5 of the second lens E2 and the object-side surface S6 of the third lens E3) on the optical axis II is 6.8531 mm, and a spacing distance W2 between the second element group G2 and the optical filter E9 (i.e., the image-side surface S17 of the eighth lens E8 and the object-side surface S18 of the optical filter E9) on the optical axis II is 6.7310 mm. At this time, an effective focal length EFL of the optical system 100 is 22.76 mm. As shown in FIG. 29, when the optical system 100 is in the long-focus state, the spacing distance W1 between the first element group G1 and the second element group G2 (i.e., the image-side surface S5 of the second lens E2 and the object-side surface S6 of the third lens E3) on the optical axis II is 2.0477 mm, and the spacing distance W2 between the second element group G2 and the optical filter E9 (i.e., the image-side surface S17 of the eighth lens E8 and the object-side surface S18 of the optical filter E9) on the optical axis II is 11.5364 mm. At this time, the effective focal length EFL of the optical system 100 is 34.13 mm.

In the present embodiment, the object-side surface and the image-side surface of any lens among the first lens E1 to the eighth lens E8 are aspherical surfaces. Table 12 shows conic coefficients K and high-order coefficients A₄, A₆, A₈, A₁₀, A₁₂, A₁₄, A₁₆, A₁₈ and A₂₀, which is applied to the aspherical surfaces S1-S2 and S4-S17 in Embodiment 6.

TABLE 12

| Surface | | | | | | | | | | |
|---|---|---|---|---|---|---|---|---|---|---|
| number | A₄ | A₆ | A₈ | A₁₀ | A₁₂ | A₁₄ | A₁₆ | A₁₈ | A₂₀ | A₄ |
| S1 | −90.000 | 4.41E−02 | 2.97E−04 | −4.29E−04 | −4.30E−05 | −2.30E−05 | 5.00E−06 | −4.00E−06 | −2.00E−06 | 2.00E−06 |
| S2 | −56.406 | −2.46E−04 | 2.12E−03 | −6.32E−04 | −2.10E−05 | −2.60E−05 | 5.00E−06 | −4.00E−06 | −1.00E−06 | 2.00E−06 |
| S4 | 90.000 | 4.85E−01 | −6.76E−02 | 1.29E−02 | −2.68E−03 | 5.81E−04 | −1.17E−04 | 3.20E−05 | −5.00E−06 | −3.00E−06 |
| S5 | −14.271 | 1.61E−01 | −3.43E−02 | 7.71E−03 | −1.75E−03 | 3.93E−04 | −7.90E−05 | 2.90E−05 | −4.00E−06 | −2.00E−06 |
| S6 | −28.568 | −2.78E−01 | 1.70E−02 | −5.18E−03 | 1.63E−03 | −2.13E−04 | −9.50E−05 | −1.60E−04 | 2.20E−05 | 1.20E−05 |
| S7 | 0.551 | −8.53E−01 | 7.05E−02 | −1.98E−02 | 4.75E−03 | −1.60E−04 | −3.73E−04 | −4.16E−04 | 1.86E−04 | −1.80E−05 |
| S8 | −0.054 | 1.21E+00 | −1.04E−01 | 2.71E−02 | −8.79E−03 | 4.27E−03 | −1.21E−03 | −2.61E−04 | 2.17E−04 | −3.50E−05 |
| S9 | −2.299 | 5.65E−01 | −1.26E−01 | 3.53E−02 | −1.31E−02 | 6.84E−03 | −2.94E−03 | 6.73E−04 | 3.74E−04 | −3.00E−05 |
| S10 | 5.837 | −3.90E−01 | 7.14E−02 | −1.77E−02 | 2.69E−03 | 6.18E−04 | −2.06E−03 | 6.99E−04 | 4.99E−04 | −6.10E−05 |
| S11 | −6.664 | −1.74E−02 | 2.56E−02 | −1.55E−02 | 3.10E−03 | −1.91E−03 | −6.90E−04 | 2.42E−04 | −2.90E−05 | −1.80E−05 |
| S12 | 0.908 | −1.17E+00 | 1.23E−01 | −2.37E−02 | 5.61E−03 | −2.81E−03 | 4.59E−04 | 7.00E−05 | 1.40E−05 | 6.00E−06 |
| S13 | 3.498 | −1.08E+00 | 8.40E−02 | −1.10E−02 | 2.85E−03 | −1.66E−03 | 9.70E−05 | 1.25E−04 | 4.50E−05 | 2.40E−05 |
| S14 | −41.756 | −5.17E−01 | −1.58E−02 | −4.94E−03 | −5.43E−04 | −7.81E−04 | −1.89E−04 | −5.80E−05 | 7.10E−05 | 3.75E−09 |
| S15 | −12.092 | −1.81E−01 | −3.03E−02 | −3.64E−03 | −2.01E−04 | −7.45E−04 | −5.00E−04 | −1.62E−04 | 1.13E−04 | 1.50E−05 |
| S16 | −21.740 | 5.76E−01 | −8.02E−02 | 1.55E−02 | −5.38E−04 | 4.68E−04 | −4.38E−04 | 1.50E−04 | 1.89E−04 | −3.50E−05 |
| S17 | −2.246 | 4.13E−01 | −7.16E−02 | 1.57E−02 | −1.18E−03 | 8.29E−04 | −1.42E−04 | 2.58E−04 | 9.60E−05 | −4.00E−05 |

FIG. 30 illustrates a longitudinal aberration curve of the optical system 100 of Embodiment 6 in the short-focus state, and the longitudinal aberration curve represents deviations of focal points of light of different wavelengths after passing through the optical system 100. FIG. 31 illustrates an astigmatism curve of the optical system 100 of Embodiment 6 in the short-focus state, and the astigmatism curve represents meridianal image surface bending and sagittal image surface bending corresponding to different image heights. FIG. 32 illustrates a distortion curve of the optical system 100 of Embodiment 6 in the short-focus state, and the distortion curve represents distortion magnitudes corresponding to different image heights. It can be seen from FIG. 30, FIG. 31 and FIG. 32 that the optical system 100 of Embodiment 6 is able to achieve good imaging quality in the short-focus state.

### Embodiment 7

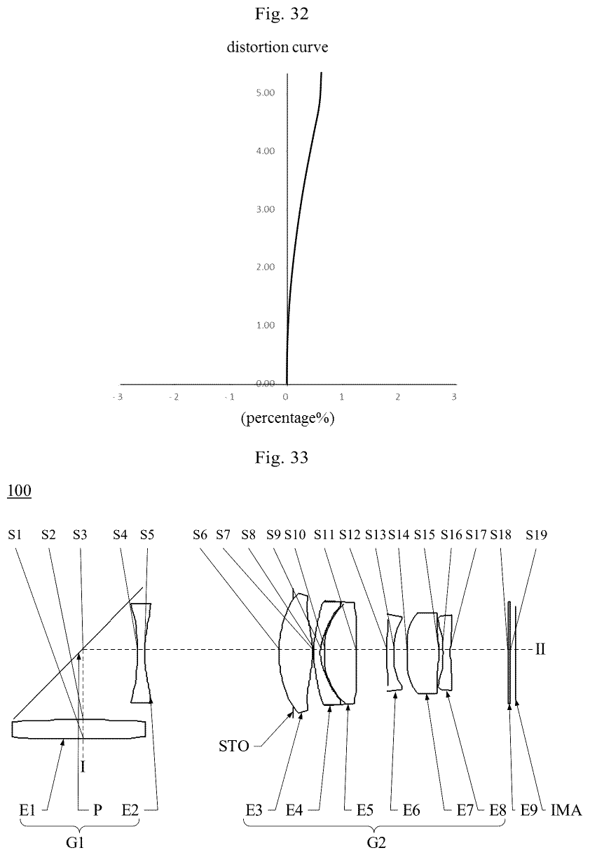

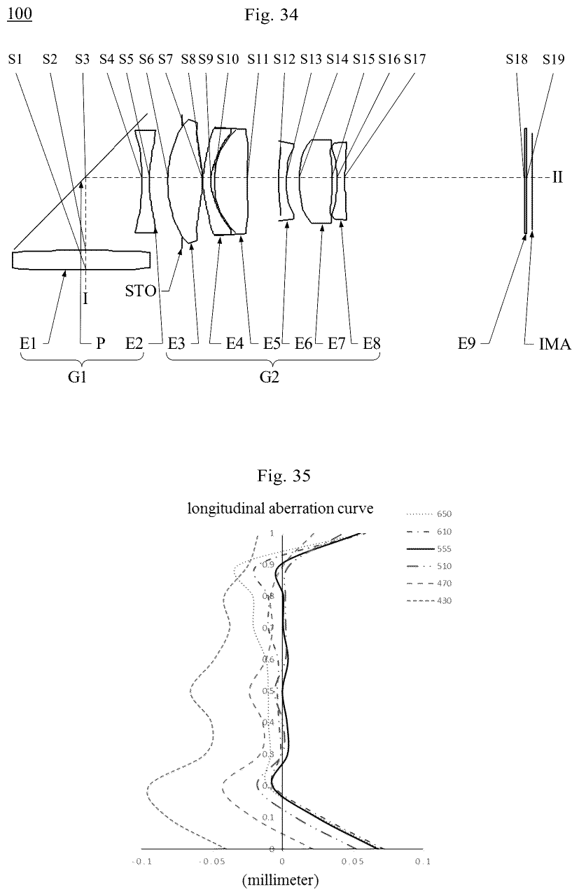

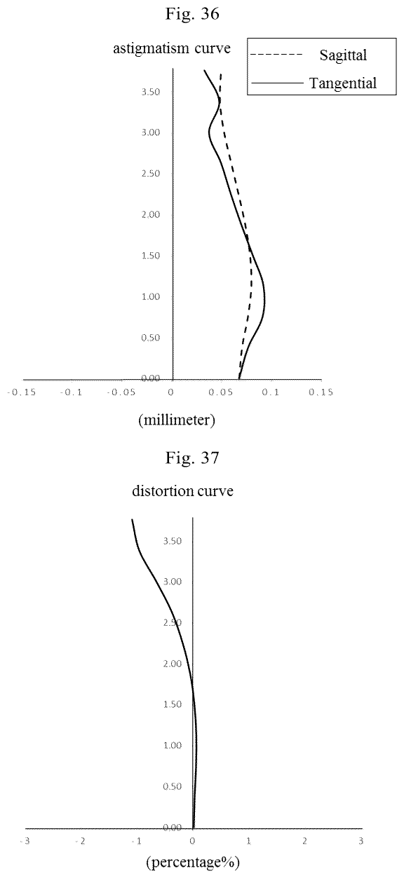

An optical system of Embodiment 7 is described below with reference to FIG. 33, FIG. 34, FIG. 35, FIG. 36 and FIG. 37. FIG. 33 illustrates a schematic structural diagram of the optical system in a short-focus state according to Embodiment 7 of the disclosure. FIG. 34 illustrates a schematic structural diagram of the optical system in a long-focus state according to Embodiment 7 of the disclosure.

As shown in FIG. 33 and FIG. 34, the optical system 100 includes a first element group G1 and a second element group G2, which are sequentially arranged from an object side to an image side. The image side is provided with an image surface IMA.

The first element group G1 includes a first lens E1, a reflective element P, and a second lens E2. The second element group G2 includes a third lens E3, a fourth lens E4, a fifth lens E5, a sixth lens E6, a seventh lens E7, and an eighth lens E8. The first lens E1 is located on an optical axis I and is disposed between the object side and the reflective element P. The second lens E2, the third lens E3, the fourth lens E4, the fifth lens E5, the sixth lens E6, the seventh lens E7 and the eighth lens E8 are sequentially arranged from the reflective element P to the image side along an optical axis II. An optical filter E9 is disposed between the eighth lens E8 and the image surface IMA. A diaphragm STO is disposed between the second lens E2 and the third lens E3.

The first lens E1 has a positive refractive power, an object-side surface S1 thereof is a convex surface, and an image-side surface S2 thereof is a convex surface. The reflective element P has a reflective surface S3, and the reflective surface S3 is a plane. The second lens E2 has a negative refractive power, an object-side surface S4 thereof is a convex surface, and an image-side surface S5 thereof is a concave surface. The third lens E3 has a positive refractive power, an object-side surface S6 thereof is a convex surface, and an image-side surface S7 thereof is a convex surface. The fourth lens E4 has a negative refractive power, an object-side surface S8 thereof is a convex surface, and an image-side surface S9 thereof is a concave surface. The fifth lens E5 has a positive refractive power, an object-side surface S10 thereof is a convex surface, and an image-side surface S11 thereof is a concave surface. The sixth lens E6 has a negative refractive power, an object-side surface S12 thereof is a concave surface, and an image-side surface S13 thereof is a convex surface. The seventh lens E7 has a positive refractive power, an object-side surface S14 thereof is a convex surface, and an image-side surface S15 thereof is a convex surface. The eighth lens E8 has a negative refractive power, an object-side surface S16 thereof is a concave surface, and an image-side surface S17 thereof is a concave surface. The optical filter E9 has an object-side surface S18 and an image-side surface S19. Light rays from an object sequentially pass through the surfaces S1 to S19 and are finally imaged on the image surface IMA.

Table 13 illustrates basic parameters of the optical system 100 of Embodiment 7, wherein the units of curvature radius and thickness/distance are millimeters (mm).

TABLE 13

| | | | | | | Material | | |
|---|---|---|---|---|---|---|---|---|
| Surface | | Surface | Curvature | Thickness/ | | Refractive | Abbe | Focal |
| number | Element | type | radius | distance | Material | index | number | length |
| S1 | First lens | Aspherical | 577.1275 | 1.5500 | Plastic | 1.671 | 19.400 | 71.63 |
| | | surface | | | | | | |
| S2 | | Aspherical | −52.9307 | 5.3800 | | | | |
| | | surface | | | | | | |
| S3 | Reflective | Spherical | Infinite | −4.7794 | | | | |
| | element | surface | | | | | | |
| S4 | Second lens | Aspherical | −100.9413 | −0.6208 | Plastic | 1.551 | 50.586 | −13.10 |
| | | surface | | | | | | |
| S5 | | Aspherical | −6.7482 | W1 | | | | |
| | | surface | | | | | | |
| STO | Aperture | Spherical | Infinite | 1.1282 | | | | |
| | | surface | | | | | | |
| S6 | Third lens | Aspherical | −9.9124 | −2.7500 | Plastic | 1.518 | 56.496 | 7.14 |
| | | surface | | | | | | |
| S7 | | Aspherical | 5.3668 | −0.0401 | | | | |
| | | surface | | | | | | |
| S8 | Fourth lens | Aspherical | −4.1760 | −0.6005 | Plastic | 1.653 | 21.479 | −10.50 |
| | | surface | | | | | | |
| S9 | | Aspherical | −2.4541 | −0.3218 | | | | |
| | | surface | | | | | | |
| S10 | Fifth lens | Aspherical | −10.2417 | −2.5901 | Plastic | 1.516 | 56.992 | 20.78 |
| | | surface | | | | | | |
| S11 | | Aspherical | −192.4135 | −2.5388 | | | | |
| | | surface | | | | | | |
| S12 | Sixth lens | Aspherical | 21.8349 | −0.6003 | Plastic | 1.648 | 22.112 | −94.47 |
| | | surface | | | | | | |
| S13 | | Aspherical | 34.1702 | −1.0660 | | | | |
| | | surface | | | | | | |
| S14 | Seventh lens | Aspherical | −3077.9823 | −2.5945 | Plastic | 1.671 | 19.400 | 12.62 |
| | | surface | | | | | | |
| S15 | | Aspherical | 8.5753 | −0.3560 | | | | |
| | | surface | | | | | | |
| S16 | Eighth lens | Aspherical | 11.2083 | −0.6016 | Plastic | 1.545 | 55.957 | −9.22 |
| | | surface | | | | | | |
| S17 | | Aspherical | −9.3321 | W2 | | | | |
| | | surface | | | | | | |
| S18 | Optical filter | Spherical | Infinite | −0.1673 | Glass | 1.517 | 64.210 | |
| | | surface | | | | | | |
| S19 | | Spherical | Infinite | −0.3945 | | | | |
| | | surface | | | | | | |
| IMA | Image | Spherical | Infinite | | | | | |
| | surface | surface | | | | | | |

During the process of the optical system 100 switching from the short-focus state to the long-focus state, the position of the first element group G1 is fixed, and the second element group G2 moves towards the first element group G1 along the optical axis II. During the process of the optical system 100 switching from the long-focus state to the short-focus state, the position of the first element group G1 is fixed, the second element group G2 moves towards the image surface IMA along the optical axis II.

As shown in FIG. 33, when the optical system 100 is in the short-focus state, a spacing distance W1 between the first element group G1 and the second element group G2 (i.e., the image-side surface S5 of the second lens E2 and the object-side surface S6 of the third lens E3) on the optical axis II is 12.1705 mm, and a spacing distance W2 between the second element group G2 and the optical filter E9 (i.e., the image-side surface S17 of the eighth lens E8 and the object-side surface S18 of the optical filter E9) on the optical axis II is 4.7754 mm. At this time, an effective focal length EFL of the optical system 100 is 11.98 mm. As shown in FIG. 34, when the optical system 100 is in the long-focus state, the spacing distance W1 between the first element group G1 and the second element group G2 (i.e., the image-side surface S5 of the second lens E2 and the object-side surface S6 of the third lens E3) on the optical axis II is 2.6193 mm, and the spacing distance W2 between the second element group G2 and the optical filter E9 (i.e., the image-side surface S17 of the eighth lens E8 and the object-side surface S18 of the optical filter E9) on the optical axis II is 14.3266 mm. At this time, the effective focal length EFL of the optical system 100 is 31.95 mm.

In the present embodiment, the object-side surface and the image-side surface of any lens among the first lens E1 to the eighth lens E8 are aspherical surfaces. Table 14 shows conic coefficients K and high-order coefficients A₄, A₆, A₈, A₁₀, A₁₂, A₁₄, A₁₆, A₁₈ and A₂₀, which is applied to the aspherical surfaces S1-S2 and S4-S17 in Embodiment 7.

TABLE 14

| Surface | | | | | | | | | | |
|---|---|---|---|---|---|---|---|---|---|---|
| number | A₄ | A₆ | A₈ | A₁₀ | A₁₂ | A₁₄ | A₁₆ | A₁₈ | A₂₀ | A₄ |
| S1 | 90.000 | 6.76E−01 | −1.08E−01 | −4.19E−03 | 1.74E−02 | −1.48E−03 | 1.53E−04 | −4.00E−04 | 3.84E−04 | −1.40E−05 |
| S2 | −82.899 | 3.94E−01 | −9.45E−02 | −2.69E−03 | 1.79E−02 | −3.01E−03 | 3.23E−04 | −2.35E−04 | 3.83E−04 | −7.30E−05 |
| S4 | −89.454 | 9.44E−01 | −1.70E−01 | 3.58E−02 | −1.23E−02 | 4.21E−03 | −1.27E−03 | 2.58E−04 | −1.44E−04 | 6.40E−05 |
| S5 | −17.433 | 1.58E−01 | −4.90E−02 | 7.42E−03 | −4.11E−03 | 1.43E−03 | −4.09E−04 | −4.50E−05 | −7.20E−05 | 3.20E−05 |
| S6 | −21.231 | −6.39E−01 | 5.05E−02 | −2.78E−02 | 8.00E−04 | 3.00E−05 | 4.41E−04 | −2.06E−04 | −1.89E−04 | 8.60E−05 |
| S7 | 0.441 | −1.99E+00 | 8.17E−02 | −1.11E−01 | 8.14E−03 | −7.69E−03 | 1.93E−03 | −2.30E−03 | −1.55E−04 | 3.30E−05 |
| S8 | −0.056 | 2.20E+00 | −1.99E−01 | 1.14E−01 | −1.11E−02 | 1.46E−02 | 1.25E−03 | −6.52E−04 | 6.20E−05 | 7.50E−04 |
| S9 | −2.384 | 4.74E−01 | −2.74E−01 | 8.70E−02 | −2.79E−02 | 1.85E−02 | −3.15E−03 | −2.12E−04 | −5.85E−04 | −1.66E−04 |
| S10 | 5.559 | −5.45E−01 | 1.94E−01 | −1.92E−02 | 1.55E−02 | 1.10E−02 | 4.45E−04 | 2.47E−04 | 3.55E−04 | −9.14E−04 |
| S11 | −50.935 | 6.40E−02 | 8.82E−02 | −3.54E−02 | 9.69E−03 | −2.48E−04 | −4.36E−04 | 2.61E−04 | −3.69E−04 | −1.72E−04 |
| S12 | 49.404 | −4.38E−01 | 1.26E−01 | −3.84E−02 | 2.74E−03 | 6.20E−05 | −3.16E−04 | −1.48E−04 | −3.90E−05 | −3.10E−05 |
| S13 | 59.819 | −8.29E−01 | 1.16E−01 | −2.16E−02 | −9.40E−05 | −3.80E−05 | −2.30E−04 | −7.00E−05 | −6.50E−05 | −3.70E−05 |
| S14 | 90.000 | −6.49E−01 | 3.15E−02 | −3.19E−04 | −6.76E−04 | −5.79E−04 | 1.95E−04 | −2.40E−05 | −2.00E−05 | 6.00E−06 |
| S15 | −36.837 | −1.12E−01 | −3.30E−02 | −3.39E−03 | −1.91E−03 | −1.69E−03 | −4.88E−04 | −1.46E−04 | −6.40E−05 | 7.00E−06 |
| S16 | −13.530 | 2.05E−01 | −6.31E−02 | −6.70E−03 | −1.76E−03 | −2.14E−03 | −3.08E−04 | −1.97E−04 | −4.90E−05 | 3.70E−05 |
| S17 | −14.964 | 2.47E−01 | −5.58E−02 | 2.60E−03 | −1.21E−03 | −1.90E−04 | 4.20E−05 | −9.00E−06 | 2.30E−05 | 2.90E−05 |

FIG. 35 illustrates a longitudinal aberration curve of the optical system 100 of Embodiment 7 in the short-focus state, and the longitudinal aberration curve represents deviations of focal points of light of different wavelengths after passing through the optical system 100. FIG. 36 illustrates an astigmatism curve of the optical system 100 of Embodiment 7 in the short-focus state, and the astigmatism curve represents meridianal image surface bending and sagittal image surface bending corresponding to different image heights. FIG. 37 illustrates a distortion curve of the optical system 100 of Embodiment 7 in the short-focus state, and the distortion curve represents distortion magnitudes corresponding to different image heights. It can be seen from FIG. 35, FIG. 36 and FIG. 37 that the optical system 100 of Embodiment 7 is able to achieve good imaging quality in the short-focus state.

Table 15 illustrates values of FOV, D1, D2, FG1, FG2, D2x, EPDx, d12, D2y, EPDy, SL and DL in Embodiments 1 to 7. The unit of FOV is degree (°), and units of other parameters are millimeters (mm). In addition, FOV, EPDx, and EPDy are values of the optical system 100 in the short-focus state.

TABLE 15

| | embodiment | | | | | | |
|---|---|---|---|---|---|---|---|
| Parameter | 1 | 2 | 3 | 4 | 5 | 6 | 7 |
| FOV | 33.94 | 25.51 | 25.14 | 34.50 | 24.93 | 25.27 | 33.62 |
| D1 | 10.20 | 9.80 | 6.53 | 9.15 | 9.40 | 5.80 | 8.90 |
| D2 | 5.04 | 5.87 | 4.33 | 4.64 | 5.05 | 3.91 | 4.47 |
| FG1 | −23.36 | −31.03 | −31.03 | −20.82 | −27.93 | −27.84 | −19.61 |
| FG2 | 10.24 | 13.27 | 12.75 | 9.54 | 12.13 | 11.78 | 9.34 |
| D2x | 7.22 | 9.53 | 7.83 | 6.53 | 7.67 | 7.14 | 5.14 |
| EPDx | 8.50 | 11.65 | 9.58 | 7.70 | 8.70 | 8.60 | 5.90 |
| d12 | 12.07 | 12.43 | 13.07 | 9.84 | 11.78 | 11.72 | 10.16 |
| D2y | 6.47 | 8.52 | 7.83 | 5.84 | 6.87 | 7.14 | 4.58 |
| EPDy | 7.66 | 10.49 | 9.58 | 6.93 | 7.83 | 8.60 | 5.28 |
| SL | 43.40 | 52.50 | 48.81 | 38.50 | 46.70 | 44.90 | 41.04 |
| DL | 4.80 | 5.40 | 5.18 | 4.35 | 4.96 | 4.81 | 9.55 |

Table 16 illustrates values of conditional expressions of the embodiments in Embodiments 1 to 7, wherein the values of the conditional expressions FOV, EFL, EPDx and EPPDy in Table 16 are all calculated by the values of FOV, EFL, EPDx and EPDy of the optical system 100 in the short-focus state.

TABLE 16

| Conditional | embodiment | | | | | | |
|---|---|---|---|---|---|---|---|
| expression | 1 | 2 | 3 | 4 | 5 | 6 | 7 |
| tan(FOV/2) | 0.31 | 0.23 | 0.22 | 0.31 | 0.22 | 0.22 | 0.30 |
| D1/CT1 | 5.67 | 5.44 | 5.60 | 5.31 | 5.93 | 5.36 | 5.74 |
| D2/CT2 | 6.17 | 6.34 | 6.53 | 5.92 | 7.05 | 6.41 | 7.21 |
| \|f1/f2\| | 4.99 | 3.90 | 3.96 | 4.58 | 4.79 | 4.08 | 5.47 |
| \|FG1/EFL\| | 1.26 | 1.22 | 1.22 | 1.25 | 1.23 | 1.22 | 1.64 |
| \|FG1/FG2\| | 2.28 | 2.34 | 2.43 | 2.18 | 2.30 | 2.36 | 2.10 |
| D2x/EPDx/d12 | 0.07 | 0.07 | 0.06 | 0.09 | 0.07 | 0.07 | 0.09 |
| D2y/EPDy/d12 | 0.07 | 0.07 | 0.06 | 0.09 | 0.07 | 0.07 | 0.09 |
| EFL/SL | 0.43 | 0.48 | 0.52 | 0.43 | 0.49 | 0.51 | 0.29 |
| DL/DEFL | 0.44 | 0.43 | 0.41 | 0.46 | 0.44 | 0.42 | 0.48 |

The disclosure further provides a camera module, which is a periscopic camera module in an embodiment. The camera module includes the above optical system and an imaging element used for converting an optical image formed by the optical system into an electrical signal.

What have been described above are only preferred embodiments of the disclosure and illustrations of the technical principles employed. It should be understood by those skilled in the art that, the invention scope involved in the disclosure is not limited to the technical solutions formed by specific combinations of the above technical features, and meanwhile should also include other technical solutions formed by any combinations of the above technical features or equivalent features thereof without departing from the invention concept, for example, technical solutions formed by mutual replacement of the above features with technical features having similar functions disclosed in the disclosure (but is not limited to).

What is claimed is:

1. An optical system, sequentially comprising from an object side to an image side along an optical axis:
a first element group and a second element group, which are sequentially disposed from the object side to the image side along the optical axis, wherein the first element group is configured for turning an optical path; the second element group is able to move to a first zoom point and a second zoom point in a direction along the optical axis, so that the optical system switches between a long-focus state and a short-focus state; and
the optical system satisfies 0.39<DL/DEFL<0.49, the DL is a movable stroke of the second element group, and the DEFL is a variation of an effective focal length of the optical system switching from the long-focus state to the short-focus state.

2. The optical system according to claim 1, wherein during a process of the optical system switching from the short-focus state to the long-focus state, a position of the first element group is fixed, the second element group moves towards the first element group along the optical axis, and an on-axis distance between the first element group and the second element group is reduced until the second element group moves to the first zoom point.

3. The optical system according to claim 1, wherein the image side of the optical system is provided with an image surface, during a process of the optical system switching from the long-focus state to the short-focus state, a position of the first element group is fixed, the second element group moves towards the image surface along the optical axis, and an on-axis distance between the first element group and the second element group is increased until the second element group moves to the second zoom point.

4. The optical system according to claim 1, wherein the optical system satisfies 2.0<|FG1/FG2|<2.5, the FG1 is an effective focal length of the first element group, and the FG2 is an effective focal length of the second element group.

5. The optical system according to claim 1, wherein the optical system satisfies 0<tan(FOV/2)<0.35 in the short-focus state, and the FOV is a maximum field of view of the optical system.

6. The optical system according to claim 1, wherein the optical system satisfies 1.2<|FG1/EFL|<1.65 in the short-focus state, the FG1 is an effective focal length of the first element group, and the EFL is the effective focal length of the optical system.

7. The optical system according to claim 1, wherein the optical system satisfies 0.25<EFL/SL<0.55 in the short-focus state, the EFL is the effective focal length of the optical system, and the SL is a total length of the optical system in a preset primary optical axis direction.

8. The optical system according to claim 1, wherein the first element group has a negative refractive power, and the second element group has a positive refractive power.

9. The optical system according to claim 1, wherein the first element group sequentially comprises, from the object side to the image side: a first lens having a positive refractive power, a reflective element, and a second lens having a negative refractive power, and the reflective element is disposed between the first lens and the second lens, and is configured for reflecting light emitted from the first lens.

10. The optical system according to claim 9, wherein the optical system satisfies 0.05 mm⁻¹<D2x/EPDx/d12<0.09 mm⁻¹ in the short-focus state, the D2x is a maximum effective half-aperture of the first lens in a first direction, the EPDx is an entrance pupil diameter of the optical system in the first direction, and the d12 is a spacing distance between an image-side surface of the first lens and an object-side surface of the second lens on the optical axis.

11. The optical system according to claim 9, wherein the optical system satisfies 0.05 mm⁻¹<D2y/EPDy/d12<0.09 mm⁻¹ in the short-focus state, wherein the D2y is a maximum effective half-aperture of the second lens in a second direction, the EPDy is an entrance pupil diameter of the optical system in the second direction, and the d12 is a spacing distance between an image-side surface of the first lens and an object-side surface of the second lens on the optical axis.

12. The optical system according to claim 9, wherein the optical system satisfies 5.2<D1/CT1<6.0, the D1 is a maximum effective half-aperture of the first lens, and the CT1 is a center thickness of the first lens on the optical axis.

13. The optical system according to claim 9, wherein the optical system satisfies 5.5<D2/CT2<7.5, the D2 is a maximum effective half-aperture of the second lens, and the CT2 is a center thickness of the second lens on the optical axis.

14. The optical system according to claim 9, wherein the optical system satisfies 3.6<|f1/f2|<5.6, the f1 is an effective focal length of the first lens, and the f2 is an effective focal length of the second lens.

15. The optical system according to claim 9, wherein a spacing distance is formed between the first lens and the reflective element, and a spacing distance is formed between the second lens and the reflective element.

16. The optical system according to claim 9, wherein the optical axis comprises a first optical axis and a second optical axis, which form a preset angle, and the second optical axis is a preset primary optical axis; and the reflective element comprises a plane mirror, the plane mirror receives light emitted from the first lens in a direction of the first optical axis, and reflects the light rays and then emits the light rays to the second lens in a direction of the second optical axis.

17. The optical system according to claim 1, wherein the optical system further comprises a lens barrel assembly, the lens barrel assembly comprises:
a first lens barrel, wherein the first element group is fixed in the first lens barrel;
a second lens barrel, wherein the second element group is fixed in the second lens barrel;
wherein during a process of the optical system switching between the short-focus state and the long-focus state, positions of the first lens barrel and the first element group disposed therein are fixed, the second lens barrel drives the second element group disposed therein to move along the optical axis.

18. The optical system according to claim 17, wherein the first element group sequentially comprises, from the object side to the image side: a first lens having a positive refractive power, a reflective element, and a second lens having a negative refractive power, and the reflective element is disposed between the first lens and the second lens, and is configured for reflecting light emitted from the first lens;
the first lens barrel is provided with a first opening located on a light incidence side and a second opening located on a light emergence side, the first lens is disposed in the first opening, the second lens is disposed in the second opening, and the reflective element is disposed between the first opening and the second opening, an inner diameter of the first opening is greater than or equal to an inner diameter of the second opening.

19. A camera module, comprising:
an optical system, wherein the optical system comprises a first element group and a second element group, which are sequentially disposed from an object side to an image side along an optical axis, the first element group is configured for turning an optical path; the second element group is able to move to a first zoom point and a second zoom point in an direction along the optical axis, so that the optical system switches between a long-focus state and a short-focus state;
the optical system satisfies 0.39<DL/DEFL<0.49, the DL is a movable stroke of the second element group, and the DEFL is a variation of an effective focal length of the optical system switching from the long-focus state to the short-focus state; and
an imaging element, wherein the imaging element is configured for converting an optical image formed by the optical system into an electrical signal.
